(19) United States
(12) Patent Application Publication
(10) Pub. No.: US 2025/0079491 A1
(43) Pub. Date: Mar. 6, 2025

(54) SOLID-STATE ELECTROLYTE SHEET, SOLID OXIDE FUEL CELL, SOLID OXIDE ELECTROLYZER CELL, AND METHODS OF MAKING THE SAME

(71) Applicant: CORNING INCORPORATED, CORNING, NY (US)

(72) Inventors: Brittany Lynn Higgins, Corning, NY (US); Rahul Suryakant Kadam, Big Flats, NY (US); Timothy Joseph Markel, Painted Post, NY (US); Yan Wang, Horseheads, NY (US); Nathan Michael Zink, Painted Post, NY (US)

(21) Appl. No.: 18/814,812

(22) Filed: Aug. 26, 2024

Related U.S. Application Data
(60) Provisional application No. 63/535,429, filed on Aug. 30, 2023.

(51) Int. Cl. H01M 8/1253; H01M 8/12

(52) U.S. Cl. CPC H01M 8/1253; H01M 2008/1293

(57) ABSTRACT

A solid-state electrolyte sheet includes scandia-stabilized zirconia grains and a thickness from 10 micrometers to 300 micrometers. In aspects, the solid-state electrolyte sheet exhibits an ionic conductivity at 850° C. of 9.5 S/cm or more. In aspects, the scandia-stabilized zirconia grains includes from 3 mol % to 11 mol % or from 3 mol % to 6 mol % scandia. In aspects, an average grain size can be from 0.1 micrometers to 2.5 micrometers. In aspects, a majority of pores can be a closed porosity. In aspects, the solid-state electrolyte sheet can be part of a solid oxide fuel cell and/or a solid oxide electrolyzer cell. Methods include casting a green tape comprising scandia-stabilized zirconia and firing the green tape to form the solid-state electrolyte sheet. In aspects, the firing can include heating at a maximum temperature of 1650° C. or less and/or heating at temperatures of 600° C. or more for 90 minutes or less.

This application claims the benefit of priority under 35 U.S.C. § 119 of U.S. Provisional Application Ser. No. 63/535,429 filed Aug. 30, 2023, the contents of which is incorporated by reference in its entirety.

### TECHNICAL FIELD

The present disclosure relates to solid-state electrolyte sheets, solid oxide fuel cells, solid oxide electrolyzer cells, and methods of making the same, and more particularly, to a solid-state electrolyte sheet comprising scandia-stabilized zirconia, solid oxide fuel cells including the same, solid oxide electrolyzer cells including the same, and methods of making the same.

### BACKGROUND

Fossil fuels have long been a primary source of energy. However, fossil fuels are finite and, when burned to produce heat, produce a suboptimal amount of air pollution and greenhouse gases. To reduce reliance on fossil fuels as an energy source, renewable energy sources such as solar energy and wind energy are being used to generate electrical energy. The generation of electrical energy spurs demand for devices that store the electrical energy that renewable energy sources (and fossil fuels too) generate in the form of chemical energy.

One chemical storage method is an electrolyzer cell, where electrical energy is converted into chemical energy (e.g., by splitting water). The chemical energy can later be harvested using a fuel cell that reverses the reaction of the electrolyzer cell. There are a variety of electrolyzer cells and fuel cells that have been developed, each employing different types of electrolyte materials (e.g., perfluorosulfonic acid (PFSA) polymers) to facilitate ion transport therethrough while avoiding a short circuit in the cell. However, PFSA electrolytes have a limited operating temperature. Consequently, there is a need for solid-state, non-polymeric electrolyte materials that exhibit high ionic conductivity and can operate a temperatures of 700° C. or more.

### SUMMARY

The present disclosure provides a solid-state electrolyte sheet, solid-oxide fuel cell, solid oxide electrolyzer cell, and methods of making the same. The solid-state electrolyte sheet can achieve high ionic conductivity (e.g., 6.5 S/cm or more at 800° C., 9.5 S/cm or more at 850° C., 13.0 S/cm or more at 900° C., or 18.0 S/cm or more at 950° C.) formed as a result of the methods of the present disclosure. Examples 1-24 demonstrate an unexpected benefit of increased ionic conductivity beyond that reported in the prior art under similar conditions. Without wishing to be bound by theory, it is believed that the closed porosity, small average grain size, small maximum grain size, and/or low porosity contribute to the unexpectedly high ionic conductivity. Without wishing to be bound by theory, it is believed that providing a low average grain size (e.g., from 0.1 μm to 2.5 μm or from 0.1 μm to 1.5 μm) can increase the ionic conductivity, for example, by decreasing a path length along grain boundaries that could be travelled by an ion transported through the solid-state electrolyte sheet. Without wishing to be bound by theory, it is believed that by limiting a maximum grain size, the ionic conductivity can be increased, for example, by decreasing a path length along grain boundaries that could be travelled by an ion transported through the solid-state electrolyte sheet and/or by providing additional grain boundary per volume of the solid-state electrolyte. Providing a majority of pores as closed pores can enable an increased ionic conductivity. Also, providing a majority of pores as closed pores can facilitate longevity of the resulting solid oxide fuel cell and/or solid oxide electrolyzer cell, for example, by reducing an incidence of short circuiting the cell through the solid state electrolyte sheet (e.g., in the case of an open pore providing a path from the first major surface to the second major surface).

Methods of the present disclosure can enable the formation of long ribbons of the solid-state electrolyte sheet. Firing a green tape to form the solid-state electrolyte sheet can comprise a single firing step or a plurality of firing steps. The one or more firing steps can comprise heating at a maximum temperature of 1650° C. or less (or 1625° C. or less or 1600° C. or less), which can facilitate formation of the microstructure (e.g., grain size, porosity, and/or associated grain size distribution) associated with the increased ionic conductivity of the solid-state electrolyte sheets of the present disclosure. Heating the green tape (at temperatures of 600° C. or more) for 90 minutes or less (e.g., from 5 minutes to 60 minutes) can reduce resource requirements and/or increase a throughput of the method. Also, a maximum period of time at the maximum temperature of from 10 seconds to 20 minutes or from 5% to 20% of the period of time in the firing step at temperatures of 600° C. or more can reduce resource requirements (e.g., energy) of the method.

Some example aspects of the disclosure are described below with the understanding that any of the features of the various aspects may be used alone or in combination with one another.

Aspect 1. A solid-state electrolyte sheet comprising:
scandia-stabilized zirconia grains comprising from about 3 mol % to about 6 mol % scandia;
a thickness in a range from about 10 micrometers to about 300 micrometers; and
an ionic conductivity at 850° C. of 9.5 S/cm or more.

Aspect 2. The solid-state electrolyte sheet of aspect 1, wherein the ionic conductivity is 9.8 S/cm or more.

Aspect 3. The solid-state electrolyte sheet of any one of aspects 1-2, wherein the scandia-stabilized zirconia grains comprise about 6 mol % scandia.

Aspect 4. The solid-state electrolyte sheet of any one of aspects 1-3, wherein the thickness is from about 20 micrometers to about 50 micrometers.

Aspect 5. The solid-state electrolyte sheet of any one of aspects 1-4, wherein the solid-state electrolyte sheet comprises a porosity of about 4% or less.

Aspect 6. The solid-state electrolyte sheet of any one of aspects 1-5, wherein a majority of pores in the solid-state electrolyte sheet is a closed porosity.

Aspect 7. The solid-state electrolyte sheet of any one of aspects 1-6, wherein an average grain size of the scandia-stabilized zirconia grains is from 0.1 μm to 2.5 μm.

Aspect 8. The solid-state electrolyte sheet of any one of aspects 1-7, wherein a maximum grain size of the scandia-stabilized zirconia grains is less than 5 μm.

Aspect 9. The solid-state electrolyte sheet of aspect 8, wherein the maximum grain size is less than 2.5 μm.

Aspect 10. The solid-state electrolyte sheet of any one of aspects 1-9, wherein the scandia-stabilized zirconia grains are substantially free of at least one of alumina, yttria, a lanthanoid oxide, or combinations thereof.

Aspect 11. The solid-state electrolyte sheet of any one of aspects 1-10, wherein the solid-state electrolyte sheet exhibits an edge strength of 350 MegaPascals or more as measured in a Two-Point Bend Test.

Aspect 12. The solid-state electrolyte sheet of any one of aspects 1-11, wherein a curvature of the solid-state electrolyte sheet is 10 Diopters or less.

Aspect 13. The solid-state electrolyte sheet of any one of aspects 1-12, wherein the solid-state electrolyte sheet exhibits a total-indicated-range of 1 millimeter or less over a distance of 25 mm or more.

Aspect 14. The solid-state electrolyte sheet of any one of aspects 1-13, wherein a maximum dimension of the solid-state electrolyte sheet is 1 meter or more.

Aspect 15. The solid-state electrolyte sheet of any one of aspects 1-14, wherein a predominant crystal phase of the scandia-stabilized zirconia grains is tetragonal.

Aspect 16. A solid-state electrolyte sheet comprising:
scandia-stabilized zirconia grains comprising from about 3 mol % to about 11 mol % scandia;
a thickness in a range from about 10 micrometers to about 300 micrometers;
an average grain size of the scandia-stabilized zirconia grains is from 0.1 μm to 2.5 μm; and
a majority of pores in the solid-state electrolyte sheet is a closed porosity.

Aspect 17. The solid-state electrolyte sheet of aspect 16, wherein the solid-state electrolyte sheet comprises a porosity of about 4% or less.

Aspect 18. The solid-state electrolyte sheet of aspect 17, wherein the porosity is in a range from 0.1% to 3%.

Aspect 19. The solid-state electrolyte sheet of any one of aspects 16-18, wherein the average grain size is from 1 micrometer to 2.2 micrometers.

Aspect 20. The solid-state electrolyte sheet of any one of aspects 16-18, wherein the average grain size is from 0.1 micrometers to 1.5 micrometers.

Aspect 21. The solid-state electrolyte sheet of any one of aspects 16-20, wherein a maximum grain size of the scandia-stabilized zirconia grains is less than 5 μm.

Aspect 22. The solid-state electrolyte sheet of aspect 21, wherein the maximum grain size is less than 2.5 μm.

Aspect 23. The solid-state electrolyte sheet of any one of aspects 16-22, wherein a distribution of grain size of the scandia-stabilized zirconia grains is contained between 0.1 μm and 3 μm.

Aspect 24. The solid-state electrolyte sheet of any one of aspects 16-23, wherein the thickness is from about 20 micrometers to about 50 micrometers.

Aspect 25. The solid-state electrolyte sheet of any one of aspects 16-24, wherein the scandia-stabilized zirconia grains comprise from about 3 mol % to about 6 mol % scandia.

Aspect 26. The solid-state electrolyte sheet of aspect 25, wherein the scandia-stabilized zirconia grains comprise about 6 mol % scandia.

Aspect 27. The solid-state electrolyte sheet of any one of aspects 16-26, wherein the solid-state electrolyte sheet comprises an ionic conductivity at 900° C. of 13.2 S/cm or more.

Aspect 28. The solid-state electrolyte sheet of aspect 27, wherein the solid-state electrolyte sheet comprises the ionic conductivity at 900° C. of 13.6 S/cm or more.

Aspect 29. The solid-state electrolyte sheet of any one of aspects 16-28, wherein the solid-state electrolyte sheet comprises an ionic conductivity at 850° C. of 9.8 S/cm or more.

Aspect 30. The solid-state electrolyte sheet of any one of aspects 16-29, wherein the scandia-stabilized zirconia grains are substantially free of at least one of alumina, yttria, a lanthanoid oxide, or combinations thereof.

Aspect 31. The solid-state electrolyte sheet of any one of aspects 16-30, wherein the solid-state electrolyte sheet exhibits an edge strength of 350 MegaPascals or more as measured in a Two-Point Bend Test.

Aspect 32. The solid-state electrolyte sheet of aspect 31, wherein the edge strength is from 500 MegaPascals to 1200 MegaPascals.

Aspect 33. The solid-state electrolyte sheet of any one of aspects 16-32, wherein a curvature of the solid-state electrolyte sheet is 10 Diopters or less.

Aspect 34. The solid-state electrolyte sheet of aspect 33, wherein the curvature is from 1

### Diopter to 6 Diopters.

Aspect 35. The solid-state electrolyte sheet of any one of aspects 16-34, wherein the solid-state electrolyte sheet exhibits a total-indicated-range of 1 millimeter or less over a distance of 25 mm or more.

Aspect 36. The solid-state electrolyte sheet of any one of aspects 16-34, wherein the solid-state electrolyte sheet exhibits a total-indicated-range of from 0.1 millimeters to 0.8 millimeters over a distance of 100 mm or more.

Aspect 37. The solid-state electrolyte sheet of any one of aspects 16-36, wherein a maximum dimension of the solid-state electrolyte sheet is 1 meter or more.

Aspect 38. The solid-state electrolyte sheet of any one of aspects 16-37, wherein a predominant crystal phase of the scandia-stabilized zirconia grains is tetragonal.

Aspect 39. A solid oxide fuel cell comprising:
the solid-state electrolyte sheet of any one of aspects 1-38 comprising a first major surface and a second major surface with the thickness defined therebetween;
an oxygen electrode disposed on the first major surface; and
a fuel electrode disposed on the second major surface.

Aspect 40. The solid oxide fuel cell of aspect 39, wherein the oxygen electrode comprises at least one of iron, manganese, gadolinium, or combinations thereof.

Aspect 41. The solid oxide fuel cell of any one of aspects 39-40, wherein the fuel electrode comprises at least one of nickel, manganese, chromium, scandium, or combinations thereof.

Aspect 42. A solid oxide electrolyzer cell comprising:
the solid-state electrolyte sheet of any one of aspects 1-38 comprising a first major surface and a second major surface with the thickness defined therebetween;
an oxygen electrode disposed on the first major surface; and
a fuel electrode disposed on the second major surface.

Aspect 43. The solid oxide electrolyzer cell of aspect 42, wherein the oxygen electrode comprises at least one of iron, manganese, or combinations thereof.

Aspect 44. The solid oxide electrolyzer cell of any one of aspects 42-43, wherein the fuel electrode comprises at least one of nickel, manganese, chromium, scandium, or combinations thereof.

Aspect 45. A method of making a solid-state electrolyte sheet comprising:
casting a green tape comprising scandia-stabilized zirconia; and
firing the green tape to form the solid-state electrolyte sheet,
wherein the firing comprises heating at a maximum temperature of 1650° C. or less and the firing comprises the heating at temperatures of 600° C. or more for 90 minutes or less, and the solid-state electrolyte sheet comprises scandia-stabilized zirconia grains comprising from about 3 mol % to about 11 mol % scandia.

Aspect 46. The method of aspect 45, wherein the firing comprises the heating at temperatures of 600° C. or more for from 5 minutes to 60 minutes.

Aspect 47. The method of any one of aspects 45-46, wherein the maximum temperature is maintained for a maximum period of time from about 10 seconds to about 20 minutes as part of a temperature ramp to the maximum temperature.

Aspect 48. The method of any one of aspects 45-46, wherein a maximum period of time at the maximum temperature, as a percentage of a total period of time heating at temperatures of 600° C. or more is from about 5% to about 20%.

Aspect 49. The method of any one of aspects 45-48, wherein the firing consists of a single firing step to the maximum temperature.

Aspect 50. The method of any one of aspects 45-48, wherein the firing comprises a plurality of firing steps.

Aspect 51. The method of any one of aspects 45-50, wherein a thickness of the solid-state electrolyte sheet is in a range from about 10 micrometers to about 300 micrometers.

Aspect 52. The method of any one of aspects 45-51, wherein an average grain size of the scandia-stabilized zirconia grains is from 0.1 μm to 2.5 μm.

Aspect 53. The method of any one of aspects 45-52, wherein a majority of pores in the solid-state electrolyte sheet is a closed porosity.

Aspect 54. The method of any one of aspects 45-53, wherein the solid-state electrolyte sheet comprises a porosity of about 4% or less.

Aspect 55. The method of any one of aspects 45-54, wherein a maximum grain size of the scandia-stabilized zirconia grains is less than 5 μm.

Aspect 56. The method of aspect 55, wherein the maximum grain size is less than 2.5 μm.

Aspect 57. The method of any one of aspects 45-56, wherein a distribution of grain size of the scandia-stabilized zirconia grains is contained between 0.1 μm and 3 μm.

Aspect 58. The method of any one of aspects 45-57, wherein the scandia-stabilized zirconia grains comprise from about 3 mol % to about 6 mol % scandia.

Aspect 59. The method of aspect 58, wherein the scandia-stabilized zirconia grains comprise about 6 mol % scandia.

Aspect 60. The method of any one of aspects 45-59, wherein the solid-state electrolyte sheet comprises an ionic conductivity at 850° C. of 9.5 S/cm or more.

Aspect 61. The method of any one of aspects 45-60, wherein the solid-state electrolyte sheet comprises an ionic conductivity at 900° C. of 13.2 S/cm or more.

Aspect 62. The method of any one of aspects 45-61, wherein the scandia-stabilized zirconia grains are substantially free of at least one of alumina, yttria, a lanthanoid oxide, or combinations thereof.

Aspect 63. The method of any one of aspects 45-62, wherein the green tape, as a wt % of the green tape, comprises:
from 55 wt % to 70 wt % of the scandia-stabilized zirconia;
from 15 wt % to 25 wt % of a solvent;
from 10 wt % to 15 wt % of a polymeric binder;
from 0.1 wt % to 5 wt % of a dispersant; and
from 0.1 wt % to 2 wt % of a protic base.

Aspect 64. The method of any one of aspects 45-63, wherein the solid-state electrolyte sheet exhibits an edge strength of 350 MegaPascals or more as measured in a Two-Point Bend Test.

Aspect 65. The method of claim 64, wherein the edge strength is from 500 MegaPascals to 1200 MegaPascals.

Aspect 66. The method of any one of aspects 45-65, wherein a curvature of the solid-state electrolyte sheet is 10 Diopters or less.

Aspect 67. The method of aspect 66, wherein the curvature is from 1 Diopter to 6 Diopters.

Aspect 68. The method of any one of aspects 45-67, wherein the solid-state electrolyte sheet exhibits a total-indicated-range of 1 millimeter or less over a distance of 25 mm or more.

Aspect 69. The method of any one of aspects 45-67, wherein the solid-state electrolyte sheet exhibits a total-indicated-range of from 0.1 millimeters to 0.8 millimeters over a distance of 100 mm or more.

Aspect 70. The method of any one of aspects 45-69, wherein a maximum dimension of the solid-state electrolyte sheet is 1 meter or more.

Aspect 71. The method of any one of aspects 45-70, wherein the scandia-stabilized zirconia used in the green tape comprises a specific surface area of 10.0 m²/g or less.

Aspect 72. The method of any one of aspects 45-70, wherein the scandia-stabilized zirconia used in the green tape comprises a median particle size from 0.3 μm to 1.0 μm.

Aspect 74. The method of any one of aspects 45-72, wherein a predominant crystal phase of the scandia-stabilized zirconia grains is tetragonal.

Aspect 75. The method of any one of aspects 45-73, wherein the method produces the solid-state electrolyte sheet of any one of claims 1-36.

### BRIEF DESCRIPTION OF THE DRAWINGS

The above and other features and advantages of aspects of the present disclosure are better understood when the following detailed description is read with reference to the accompanying drawings, in which:

FIG. 1 is a schematic cross-sectional view of a solid oxide electrolyzer cell in accordance with aspects of the present disclosure;

FIG. 2 is a schematic cross-sectional view of a solid oxide fuel cell in accordance with aspects of the present disclosure;

FIG. 3 is a schematic cross-section view of a solid-state electrolyte sheet in accordance with aspects of the present disclosure;

FIG. 4 is an enlarged view 4 of FIG. 3 showing a plurality of grains and a closed pore;

FIG. 5 is a flowchart of a method of manufacturing the solid-state electrolyte sheet shown in FIG. 3 and/or the cells shown in FIGS. 1-2 in accordance with aspects of the present disclosure;

FIG. 6 schematically illustrates a step of methods comprising forming a slip for a green tape in accordance with aspects of the present disclosure;

FIG. 7 schematically illustrates a temperature profile for firing a green tape in accordance with aspects of the present disclosure;

FIG. 8 schematically illustrates a temperature profile comprising a plurality of heating steps for firing a green tape in accordance with aspects of the present disclosure;

FIG. 9 schematically illustrates a step of firing a green tape in accordance with aspects of the present disclosure;

FIGS. 10-14 schematically illustrate scanning electronic microscope (SEM) images of cross-sections of Examples 1-5;

FIGS. 15-20 schematically illustrate scanning electron microscope (SEM) images of cross-sections of Examples 6-11;

FIGS. 21-24 schematically illustrate scanning electron microscope (SEM) images of cross-sections of Examples 12-15;

FIGS. 25-26 illustrate results of X-ray diffraction (XRD) analysis of Example 6;

FIGS. 27-30 schematically illustrate scanning electron microscope (SEM) images of cross-sections of Examples 12-15;

FIGS. 31-34 schematically illustrate scanning electron microscope (SEM) images of cross-sections of Examples 16-19; and

FIGS. 35-39 schematically illustrate scanning electron microscope (SEM) images of cross-sections of Examples 20-24.

### DETAILED DESCRIPTION

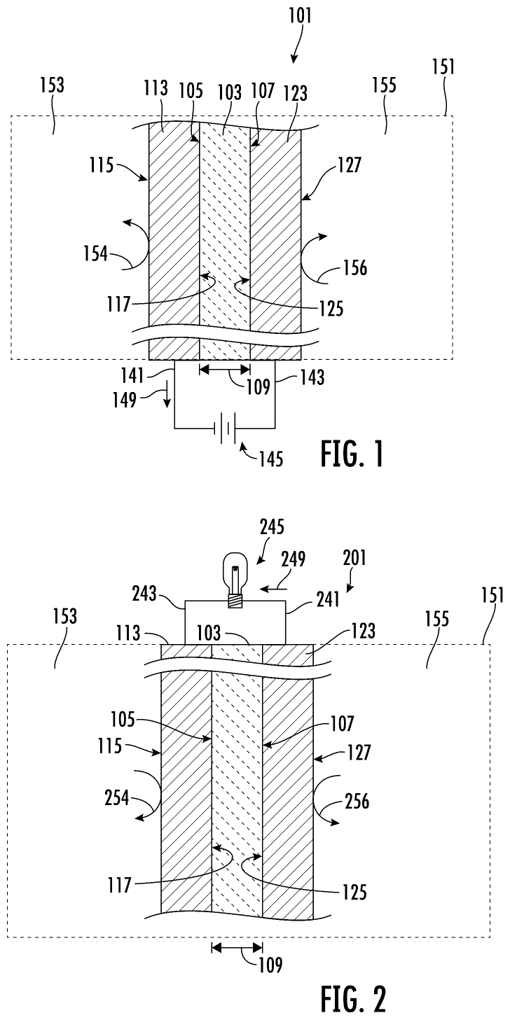

As shown in FIG. 1, a solid oxide electrolyzer cell 101 includes an oxygen electrode 113, a solid-state electrolyte sheet 103, and a fuel electrode 123 with the solid-state electrolyte sheet 103 positioned between the oxygen electrode 113 and the fuel electrode 123. As shown in FIG. 2, a solid oxide fuel cell 201 includes the oxygen electrode 113, the solid-state electrolyte sheet 103, and the fuel electrode 123 with the solid-state electrolyte sheet 103 positioned between the oxygen electrode 113 and the fuel electrode 123. As indicated by the common arrangement of the oxygen electrode 113, the solid-state electrolyte sheet 103, and the fuel electrode 123 for the solid oxide electrolyzer cell 101 and the solid oxide fuel cell 201, a common apparatus can be used as both the solid oxide electrolyzer cell 101 and the solid oxide fuel cell 201. Consequently, the oxygen electrode 113 and the fuel electrode 123, respectively, will be discussed together for the solid oxide electrolyzer cell 101 and the solid oxide fuel cell 201. Likewise, unless otherwise noted, a discussion of features of aspects of one solid-state electrolyte sheet can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

As shown in FIG. 1, the solid oxide electrolyzer cell 101 can convert electrical energy (e.g., from a battery 145 or other power source flowing through wires 141 and 143 as shown by arrow 149) to chemical energy (e.g., as shown by reaction arrows 154 and 156 at the respective electrodes 113 and 123), for example, for energy storage, with oxygen ions traveling from the fuel electrode 123 to the oxygen electrode 113 through the solid-state electrolyte sheet 103. In contrast, as shown in FIG. 2, the solid oxide fuel cell 201 can convert chemical energy (e.g., as shown by reaction arrows 254 and 256 at the respective electrodes 113 and 123 in the opposite direction of reaction arrows 154 and 156 shown in FIG. 2) to electrical energy (e.g., that can be used to power a lightbulb 245 or other equipment such as a vehicle with electricity flowing through wires 241 and 243 as indicated by the arrow 249), for example, for energy production, with oxygen ions traveling from the oxygen electrode 113 to the fuel electrode 123 through the solid-state electrolyte sheet 103 (opposite the direction for the solid oxide electrolyzer cell 101).

As shown in FIGS. 1-2, the solid oxide electrolyzer cell 101 and/or the solid oxide fuel cell 201 includes the oxygen electrode 113 with a third major surface 117 facing and/or contacting a first major surface 105 of the solid-state electrolyte sheet 103. In aspects, the oxygen electrode can comprise at least one of iron (Fe), manganese (Mn), gadolinium (Gd), or combinations thereof. The oxygen electrode is configured to facilitate a reaction between an oxygen-containing source and oxygen ions (or vice versa). In aspects, as shown in FIGS. 1-2, the reaction is configured to occur at a fourth major surface 115 of the oxygen electrode 113 opposite the third major surface 117. For example, as shown in FIG. 1 by reaction arrow 154, the oxygen electrode 113 of the solid oxide electrolyzer cell 101 can facilitate a reaction (e.g., oxidation) from oxygen ions (e.g., O²⁻) traveling through the solid-state electrolyte sheet 103 from the fuel electrode 123 into an oxygen-containing compound (e.g., diatomic oxygen—O₂) that can be released into an oxygen-containing region 153 (and electrons—e⁻—that can travel through wire 141 as indicated by arrow 149 to the battery 145 or other power source). An example half-cell reaction occurring at the oxygen electrode 113 (e.g., fourth major surface 115) is O²⁻→½O₂+2^{e-}. Alternatively, as shown in FIG. 2 by reaction arrow 254, the opposite reaction can occur at the oxygen electrode 113 (e.g., fourth major surface 115) converting (e.g., reducing) an oxygen-containing source (e.g., from the oxygen-containing region 153) into an oxygen ion (e.g., O²⁻ that can then travel into and/or through the solid-state electrolyte sheet 103) using electrons e (e.g., from wire 241 as indicated by arrow 249). In a case where the oxygen-containing source is diatomic oxygen, an example half-cell reaction occurring at the oxygen electrode 113 (e.g., fourth major surface 115) is ½ O₂+2 e⁻→O²⁻.

In aspects, the oxygen-containing region 153 can comprise any oxygen-containing material used or produced by reaction(s) occurring at the oxygen electrode 113. For example, the oxygen-containing material can be oxygen (e.g., diatomic oxygen), ozone, a peroxide (e.g., hydrogen peroxide), or a material containing one or more of the above (e.g., air containing oxygen). A preferred aspect of the oxygen-containing material is air, which naturally includes oxygen (i.e., diatomic oxygen). In aspects, as shown in FIGS. 1-2, the oxygen-containing region 153 can be demarcated by a body 151 of the corresponding cell or a device that is configured to utilize the corresponding cell. In further aspects, the oxygen-containing region 153 can be in fluid communication with an environment, for example, to allow the free flow of air therethrough (while the fuel-containing region 155 may not be open to the environment). Alternatively, in further aspects, the oxygen-containing region can be a cartridge or other storage device configured to supply the oxygen-containing material.

As shown in FIGS. 1-2, the solid oxide electrolyzer cell 101 and/or the solid oxide fuel cell 201 includes the fuel electrode 123 with a fifth major surface 125 facing and/or contacting a second major surface 107 of the solid-state electrolyte sheet 103. In aspects, the oxygen electrode can comprise at least one of nickel (Ni), manganese (Mn), chromium (Cr), scandium (Sc), or combinations thereof. The fuel electrode is configured to facilitate a reaction between an oxygen-accepting source and another oxygen-containing source (or vice versa). In aspects, as shown in FIGS. 1-2, the reaction is configured to occur at a sixth major surface 127 of the fuel electrode 123 opposite the fifth major surface 125. For example, as shown in FIG. 1 by reaction arrow 156, the fuel electrode 123 of the solid oxide electrolyzer cell 101 can facilitate a conversion (e.g., reduction) of the another oxygen-containing source from a fuel-containing region 155 (and electrons—e⁻—that can travel through wire 143 as indicated by arrow 149 from the battery 145 or other power source) to form the oxygen-accepting source. In case where the another oxygen-containing source is water (H₂O), an example half-cell reaction occurring at the fuel electrode 123 (e.g., sixth major surface 127) is H₂O+2 e⁻→H₂+O²⁻. Alternatively, as shown in FIG. 2 by reaction arrow 256, the opposite reaction can occur at the fuel electrode 123 (e.g., sixth major surface 127) involving reacting (e.g., oxidizing) the oxygen-accepting source with an oxygen ion (e.g., O²⁻ that travelled through the solid-state electrolyte sheet 103 from the oxygen electrode 113) to form the oxygen-containing source and releasing electrons e that can travel along wire 241 as indicated by arrow 249 (e.g., that can be used to power a lightbulb 245 or other equipment such as a vehicle). In a case where the oxygen-accepting source is hydrogen H₂, an example half-cell reaction occurring at the fuel electrode 123 (e.g., sixth major surface 127) is H₂+O²⁻→H₂O+2 e⁻.

In aspects, the fuel-containing region 155 can comprise any oxygen-accepting material (e.g., “fuel”) used or produced by reaction(s) occurring at the fuel electrode 123 and/or any oxygen-containing material configured to be used in the reverse reaction (e.g., reaction arrow 256). For example, the another oxygen-containing material can be water (e.g., diatomic oxygen), a peroxide (e.g., hydrogen peroxide), alcohols (e.g., methanol, ethanol), an alkali-containing material (e.g., potassium carbonate), or a material containing one or more of the above. A preferred aspect of the another oxygen-containing material is water (i.e., H₂O). The oxygen-accepting material can be a material corresponding to the another oxygen-containing material after an oxidation reaction with an oxygen ion. For example, the oxygen-accepting material can be hydrogen (e.g., H₂), a hydrocarbon (e.g., methane, ethane, syngas, natural gas), an alkali-containing material (e.g., an alkali hydroxide, for example potassium hydroxide, which can be used in combination with carbon dioxide), or a material containing one or more of the above. A preferred aspect of the oxygen-accepting material is hydrogen (i.e., H₂). In aspects, as shown in FIGS. 1-2, the fuel-containing region 155 can be demarcated by a body 151 of the corresponding cell or a device that is configured to utilize the corresponding cell. In further aspects, the fuel-containing region 155 can be a cartridge or other storage device configured to supply the oxygen-accepting material.

In aspects, although not shown, a current collector can be disposed on the oxygen electrode and/or the fuel electrode, for example, to facilitate the attachment of and/or conveyance of electrons to and/or from the wires. Alternatively, in aspects, as shown in FIGS. 1-2, the wires can be directly attached to the corresponding electrodes. For example, one or both of the electrodes may function as a current collector in addition to being an electrode.

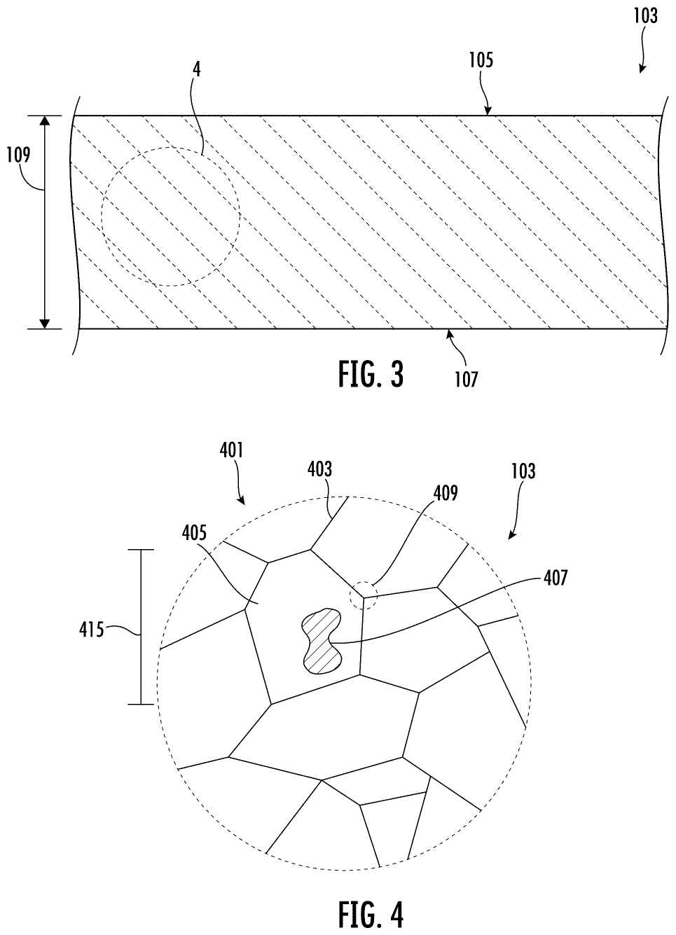

As shown in FIGS. 1-3, the solid-state electrolyte sheet 103 comprises a first major surface 105 and a second major surface 107 opposite the first major surface 105. In aspects, as shown in FIGS. 1-2, the first major surface 105 of the solid-state electrolyte sheet 103 can face and/or contact the third major surface 117 of the oxygen electrode 113. In aspects, as shown in FIGS. 1-2, the second major surface 107 of the solid-state electrolyte sheet 103 can face and/or contact the fifth major surface 125 of the fuel electrode 123. As shown, a thickness 109 of the solid-state electrolyte sheet 103 is defined as an average distance between the first major surface 105 and the second major surface 107. In aspects, the thickness 109 can be about 10 micrometers (μm) or more, about 15 μm or more, about 20 μm or more, about 25 μm or more, about 30 μm or more, about 35 μm or more, about 40 μm or more, about 300 μm or less, about 200 μm or less, about 160 μm or less, about 120 μm or less, about 100 μm or less, about 80 μm or less, about 60 μm or less, about 50 μm or less, or about 40 μm or less. In aspects, the thickness 109 can be in a range from about 10 μm to about 300 μm, from about 10 μm to about 200 μm, from about 10 μm to about 160 μm, from about 15 μm to about 120 μm, from about 15 μm to about 100 μm, from about 20 μm to about 80 μm, from about 20 μm to about 60 μm, from about 20 μm to about 50 μm, from about 25 μm to about 50 μm, from about 30 μm to about 50 μm, or any range or subrange therebetween. In further aspects, preferred ranges for the thickness 109 can be from about 10 μm to about 300 μm, from about 20 μm to about 50 μm, or from about 30 μm to about 50 μm. The thickness 109 of the solid-state electrolyte sheet 103 can be determined from a scanning electron microscope (SEM) image of a cross-section of the solid-state electrolyte sheet 103, for example with the view shown in FIG. 3. In aspects, a maximum dimension (e.g., length) of the solid-state electrolyte sheet 103 can be 100 millimeters (mm or more), 500 mm or more, 1 meter (m) or more, 5 meters or more, 10 meters or more, 20 meters or more, 50 meters or more, or 100 meters or more, for example, in a range from 100 mm to about 1,000 meters, from about 500 mm to about 500 mm, from about 1 meter to about 200 meters, from about 5 meters to about 100 meters, from about 10 meters to about 50 meters, or any range or subrange therebetween. Methods of the present disclosure can enable the formation of long ribbons of the solid-state electrolyte sheet.

FIG. 3 shows the solid-state electrolyte sheet 103, and FIG. 4 shows an enlarged view 4 of FIG. 3. The solid-state electrolyte sheet 103 comprises scandia-stabilized zirconia grains. For example, FIG. 4 shows a plurality of grains 401 with grain boundaries 403. In aspects, the solid-state electrolyte sheet 103 is an inorganic material, which can be free or substantially free of organic materials. For example, the solid-state electrolyte sheet 103 can be distinguished from a polymeric electrolyte sheet (e.g., a PFSA electrolyte). In aspects, the solid-state electrolyte sheet 103 consists essentially of or consists of scandia-stabilized zirconia. In aspects, an amount of scandia-stabilized zirconia in solid-state electrolyte sheet 103, based on 100 wt % of the solid-state electrolyte sheet 103, can be about 70 wt % or more, 80 wt % or more, 85 wt % or more, 90 wt % or more, 95 wt % or more, 99 wt % or more, 99.5 wt % or more, 99.9 wt % or more, or 100 wt %. As used herein, “scandia-stabilized zirconia” means that zirconia contains scandia (e.g., Sc₂O₃) as a stabilizer. In aspects, an amount of scandia in the scandia-stabilized zirconia grains, as a mol % of the scandia-stabilized zirconia grains, can be about 3 mol % or more, about 4 mol % or more, about 5 mol % or more, about 5.5 mol % or more, about 6 mol % or more, about 8 mol % or more, about 9 mol % or more, about 11 mol % or less, about 10.5 mol % or less, about 10 mol % or less, about 8 mol % or less, about 7 mol % or less, about 6.5 mol % or less, or about 6 mol % or less. In aspects, an amount of scandia in the scandia-stabilized zirconia grains, as a mol % of the scandia-stabilized zirconia grains, can be in a range from about 3 mol % to about 11 mol %, from about 3 mol % to about 10 mol %, from about 4 mol % to about 9 mol %, from about 4 mol % to about 8 mol %, from about 5 mol % to about 7 mol %, from about 5.5 mol % to about 6 mol %, or about 6 mol %. In aspects, preferred content of scandia in the scandia-stabilized zirconia grains includes from about 3 mol % to about 11 mol %, from about 3 mol % to about 6 mol %, or about 6 mol %. In aspects, the scandia-stabilized zirconia can be substantially free and/or free of at least one of alumina, yttria, a lanthanoid oxide, or combinations thereof. As used herein, substantially free means less than 0.1 mol %. In aspects, the scandia-stabilized zirconia can have a purity of 95% or more, 97% or more, 98% or more, 99.0% or more, 99.5% or more, or 99.7% or more.

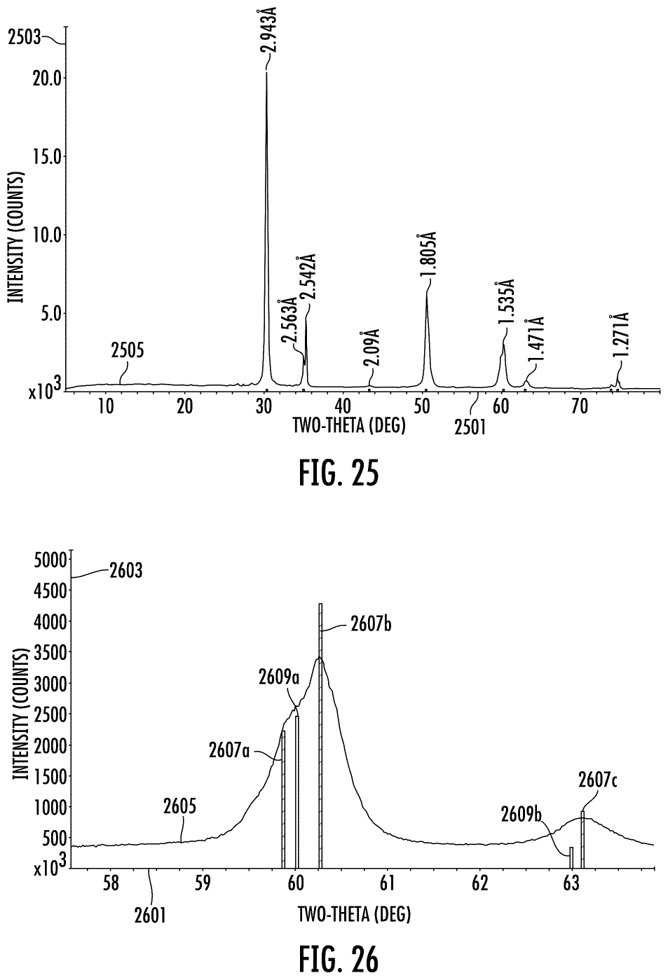

Throughout the disclosure, a crystallinity and/or relative proportion of crystal phases can be determined using X-ray diffraction (XRD). Using the reference crystallographic data for zirconia and scandia-stabilized zirconia crystal phases, a measured XRD spectrum can be fit with a series of curves associated with different aspects of the various crystal phases. A total area of the fitted curves associated with each crystal phase relative to the total area of all fitted curves is assumed to be proportional to a relative amount of the corresponding crystal phase in the sample. In aspects, the predominant crystal phase of the scandia-stabilized zirconia grains can be tetragonal. As used herein, a “predominant crystal phase” has a relative amount in the scandia-stabilized zirconia grains that is greater than any of other crystal phases on their own. In further aspects, the tetragonal crystal phase can be present in a relative amount that is greater than a total, relative amount of all other crystal phases present in the scandia-stabilized zirconia grains. In further aspects, an amount of the tetragonal crystal phase, as percentage of all crystal phases in the scandia-stabilized zirconia grains, can be 50% or more, 66% or more, 75% or more, 80% or more, 85% or more, 90% or more, 92% or more, 95% or more, 96% or more, 97% or more, 98% or more, or 99% or more. For example, FIGS. 25-26 show XRD spectra of Example 6. In FIGS. 25-26, the horizontal axis 2501 or 2601 (e.g., x-axis) corresponds to two theta (2θ) in degrees) (°) where θ is the inclination of the incident X-rays that is detected at a diffraction angle of 2θ; and the vertical axis 2503 or 2603 is a relative intensity of the diffraction peaks that is proportional to a number of detected diffracted X-rays. In FIG. 25, spectrum 2505 shows several diffraction peaks that are all associated with the tetragonal crystal phase. Consequently, spectrum 2505 indicates that greater than 99% (e.g., about 100%) of the crystal phases in the scandia-stabilized zirconia grains is tetragonal. In FIG. 26, additional sampling was performed and the zoomed-in portion of the spectrum 2605 shows two peaks that can be fit using curves centered at the locations shown, where curves 2607a-2607c are associated with the tetragonal crystal phase and curves 2609a-b are associated with a cubic zirconia crystal phase. In combination with the other diffraction peaks (including those outside of the zoomed-in range shown in FIG. 26), a relative amount of the tetragonal crystal phase in the scandia-stabilized zirconia grains is still estimated to be 99% or more.

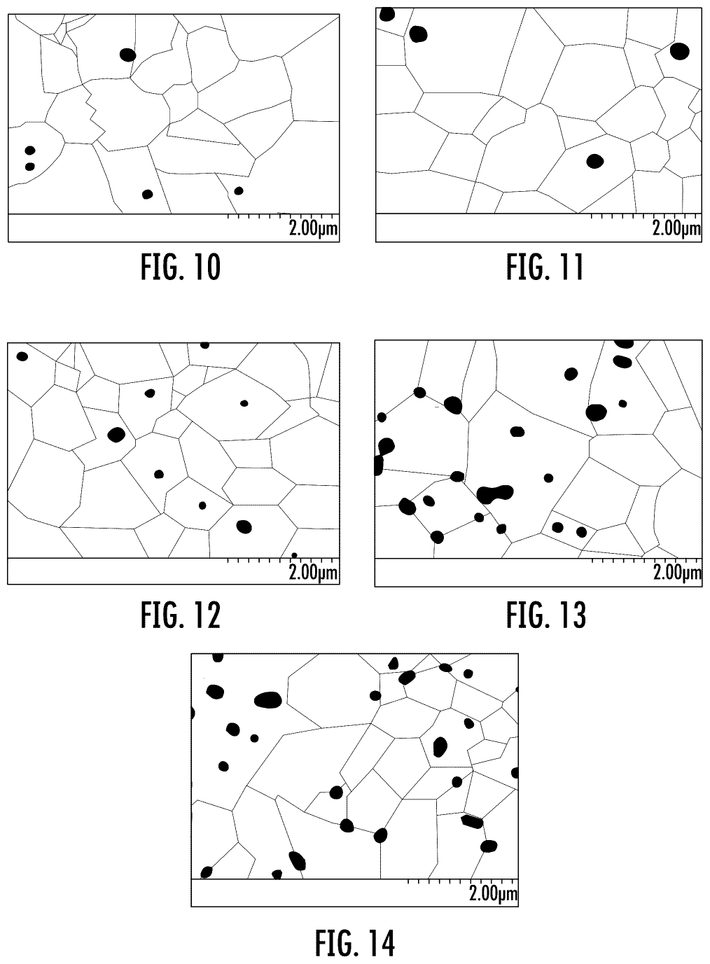

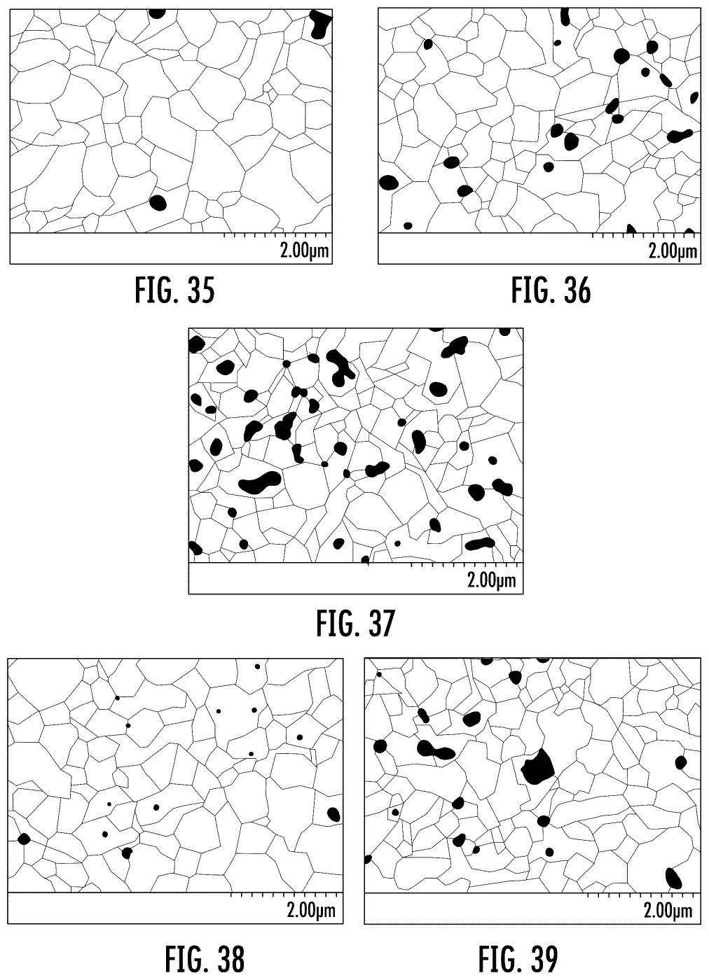

Throughout the disclosure, a grain size of the scandia-stabilized zirconia grains is determined in accordance with ASTM E112-13. As such, a scanning electron microscope (SEM) image is taken of a cross-section (as shown schematically in FIG. 4 and from experimental measurement of Examples 1-24 in FIGS. 10-24 and 27-39). For determining the grain size distribution (e.g., minimum, maximum, mean), the SEM images was taken at 20,000 times magnification and at least 20% of the area in the SEM image is analyzed to determine the grain size distribution. For example, a grain size 415 is shown for grain 405 of the plurality of grains in FIG. 4. From the calculated grain sizes, values such as the average (e.g., mean), maximum, and minimum values of the resulting distribution of grain sizes can be calculated. In aspects, an average (e.g., mean) grain size of the scandia-stabilized zirconia grains can be about 2.5 μm or less, about 2.2 μm or less, about 2.0 μm or less, about 1.8 μm or less, about 1.5 μm or less, about 1.2 μm or less, about 1.0 μm or less, about 0.9 μm or less, about 0.8 μm or less or less, about 0.7 μm or less, about 0.6 μm or less, about 0.5 μm or less, about 0.1 μm or more, about 0.2 μm or more, about 0.3 μm or more, about 0.4 μm or more, about 0.5 μm or more, about 0.6 μm or more, about 0.7 μm or more, about 0.8 μm or more, about 0.9 μm or more, about 1.0 μm or more, about 1.1 μm or more, about 1.2 μm or more, about 1.3 μm or more, about 1.5 μm or more, about 1.8 μm or more, or about 2.0 μm or more. In aspects, the average (e.g., mean) grain size of the scandia-stabilized zirconia grains can in a range from about 0.1 μm to about 2.5 μm, from about 0.1 μm to about 2.2 μm, from about 0.2 μm to about 2.0 μm, from about 0.2 μm to about 1.8 μm, from about 0.3 μm to about 1.5 μm, from about 0.3 μm to about 1.2 μm, from about 0.4 μm to about 1.0 μm, from about 0.4 μm to about 0.9 μm, from about 0.5 μm to about 0.8 μm, from about 0.5 μm to about 0.7 μm, or any range or subrange therebetween. In aspects, the average grain size of the scandia-stabilized zirconia grains can be about 1.0 μm or more, for example, in a range from about 1.0 μm to about 2.5 μm, from about 1.0 μm to about 2.2 μm, from about 1.1 μm to about 2.0 μm, from about 1.2 μm to about 1.8 μm, from about 1.3 μm to about 1.5 μm, or any range or subrange therebetween. In aspects, the average grain size of the scandia-stabilized zirconia grains can be in a range from about 0.1 μm to about 1.8 μm, from about 0.1 μm to about 1.5 μm, from about 0.1 μm to about 1.2 μm, from about 0.1 μm to about 1.0 μm, from about 0.1 μm to about 0.8 μm, from about 0.1 μm to about 0.7 μm, from about 0.1 μm to about 0.6 μm, from about 0.1 μm to about 0.5 μm, from about 0.2 μm to about 0.4 μm, or any range or subrange therebetween. In aspects, preferred ranges for the average grain size of the scandia-stabilized zirconia grains can be in a range from about 0.1 μm to about 2.5 μm, from about 1.0 μm to about 2.2 μm, or from about 0.1 μm to about 1.5 μm. Without wishing to be bound by theory, it is believed that providing a low average grain size (e.g., from 0.1 μm to 2.5 μm or from 0.1 μm to 1.5 μm) can increase the ionic conductivity, for example, by decreasing a path length along grain boundaries that could be travelled by ion transported through the solid-state electrolyte sheet.

In aspects, a maximum grain size of the scandia-stabilized zirconia grains can be about 5 μm or less, about 4.5 μm or less, about 4 μm or less, about 3.5 μm or less, about 3 μm or less, about 2.8 μm or less, about 2.5 μm or less, about 2.2 μm or less, about 2.0 μm or less, about 1.8 μm or less, about 1.5 μm or less, about 1.2 μm or less, about 1.0 μm or less, about 0.8 μm or less, or about 0.5 μm or less. In aspects, a maximum grain size of the scandia-stabilized zirconia grains can be in a range from about 0.1 μm to about 5 μm, from about 0.2 μm to about 4.5 μm, from about 0.3 μm to about 4 μm, from about 0.4 μm to about 3.5 μm, from about 0.5 μm to about 3 μm, from about 0.6 μm to about 2.8 μm, from about 0.7 μm to about 2.5 μm, from about 0.8 μm to about 2.2 μm, from about 0.9 μm to about 2.0 μm, from about 1.0 μm to about 1.8 μm, from about 1.2 μm to about 1.5 μm, or any range or subrange therebetween. In aspects, a distribution of grain sizes of the scandia-stabilized zirconia grains can be contained in a range from about 0.1 μm to about 5 μm, from about 0.1 μm to about 4 μm, from about 0.1 μm to about 3 μm, from about 0.1 μm to about 2.8 μm, from about 0.1 μm to about 2.5 μm, from about 0.1 μm to about 2.2 μm, from about 0.1 μm to about 2.0 μm, from about 0.1 μm to about 1.8 μm, from about 0.1 μm to about 1.5 μm, from about 0.1 μm to about 1.2 μm, from about 0.1 μm to about 1.0 μm, from about 0.1 μm to about 0.8 μm, from about 0.1 μm to about 0.5 μm, or any range or subrange therebetween. Without wishing to be bound by theory, it is believed that by limiting a maximum grain size, the ionic conductivity can be increased, for example, by decreasing a path length along grain boundaries that could be travelled by ion transported through the solid-state electrolyte sheet and/or by providing additional grain boundary per volume of the solid-state electrolyte.

Throughout the disclosure, the porosity of the solid-state electrolyte sheet is determined in accordance with ASTM E1245-03. For example, the SEM image used for determining grain size can be reanalyzed to determine the number and size of pores. However, as used herein, the porosity is determined from SEM images at 5,000 times magnification, where at least 20% of each SEM image is analyzed, and the results of analyzing seven (7) SEM images are averaged to determine the porosity distribution (e.g., minimum, maximum, mean). As schematically illustrated in FIG. 4, the solid-state electrolyte sheet 103 can have closed pores 407 or open pores (indicated by region 409). As used herein, closed pores occur within a grain and are unlikely to continue beyond the grain. As such, a path cannot be formed through the thickness of the solid-state electrolyte sheet using closed grains. In contrast, as used herein, open pores occur at grain boundaries (e.g., region 409 is located at the intersection of grain boundaries 403 and can form a continuous path through the solid-state electrolyte sheet 103. In aspects, a majority (e.g., greater than 50%) of pores in the solid-state electrolyte sheet 103 can be closed pores. In aspects, a percentage of pores in the solid-state electrolyte sheet 103 that are closed pores can be 55% or more, 66% or more, 75% or more, 80% or more, 85% or more, 90% or more, 95% or more, 97% or more, 99% or more, 100% or less, 99% or less, 98% or less, 96% or less, 94% or less, 92% or less, 90% or less, 88% or less, 85% or less, or 80% or less. In aspects, a percentage of pores in the solid-state electrolyte sheet 103 that are closed pores can be in a range from 55% to 100%, from 66% to 99%, from 75% to 98%, from 80% to 96%, from 82% to 94%, from 85% to 92%, from 90% to 92%, or any range or subrange therebetween. Without wishing to be bound by theory, it is believed that ionic conductivity decreases exponentially with increasing open porosity. Providing a majority of pores as closed pores can enable an increased ionic conductivity. Also, providing a majority of pores as closed pores can facilitate longevity of the resulting solid oxide fuel cell and/or solid oxide electrolyzer cell, for example, by reducing an incidence of short circuiting the cell through the solid state electrolyte sheet (e.g., in the case of an open pore providing a path from the first major surface to the second major surface).

In aspects, a porosity of the solid-state electrolyte sheet 103 can be about 4% or less, about 3.5% or less, about 3% or less, about 2.8% or less, about 2.5% or less, about 2.0% or less, about 1.8% or less, about 1.5% or less, about 1.2% or less, about 1.0% or less, about 0.8% or less, about 0.5% or less, about 0.1% or more, about 0.2% or more, about 0.3% or more, about 0.4% or more, about 0.5% or more, about 0.6% or more, about 0.7% or more, about 0.8% or more, about 1.0% or more, about 1.2% or more, about 1.5% or more, about 1.8% or more, or about 2.0% or more. In aspects, a porosity of the solid-state electrolyte sheet 103 can be in a range from about 0.1% to about 4%, from about 0.1% to about 3.5%, from about 0.1% to about 3%, from about 0.2% to about 2.8%, from about 0.3% to about 2.5%, from about 0.4% to about 2.2%, from about 0.5% to about 2.0%, from about 0.6% to about 1.8%, from about 0.7% to about 1.5%, from about 0.8 to about 1.0%, or any range or subrange therebetween. In aspects, preferred ranges for the porosity are from about 0.1% to about 4%, from about 0.1% to about 3%, and from about 0.5% to about 2.5%.

The solid-state electrolyte sheet 103 can have low curvature and/or low surface variability. Throughout the disclosure, a “surface profile” of the solid-state electrolyte sheet is determined using a LJ-X line profilometer available from Keyence. The solid-state electrolyte sheet is freely resting on a flat surface (i.e., not restrained) when the optical measurements used to determine the surface profile are taken. Measurements are taken every 333 μm (i.e., 3 times every millimeter). As used herein, the “total-indicated-range” (TIR) is measured for measured heights within 1 mm (exclusive) of one another (i.e., a sliding window of 3 measurements when measurements are taken 3 times every millimeter) as the maximum difference in measured height between those measurements. The TIR reported and claimed herein are described as being for a predetermined length of a surface of the solid-state electrolyte sheet to provide a representative sampling of the variability in surface height across the solid-state electrolyte sheet. When the TIR is reported for a length greater than 1 mm, the reported TIR is the average TIR measured for the 1 mm sliding windows contained within that length. For example, a TIR reported over a length of 25 mm refers to the average of the maximum differences between pairs of points within 1 mm (exclusive) of each other (i.e., the maximum value of the maximum differences calculated for 74 different positions for the 1 mm sliding window and then those measurements are averaged). In aspects, a TIR of the solid-state electrolyte sheet 103 over a distance of 25 mm or more can be about 1.5 mm or less, about 1.0 mm or less, about 0.9 mm or less, about 0.8 mm or less, about 0.7 mm or less, about 0.5 mm or less, about 0.4 mm or less, about 0.3 mm or less, about 0.1 mm or more, about 0.2 mm or more, about 0.3 mm or more, or about 0.5 mm or more. In aspects, a TIR of the solid-state electrolyte sheet 103 over a distance of 25 mm or more can be in range from about 0.1 mm to about 1.5 mm, from about 0.1 mm to about 1.0 mm, from about 0.1 mm to about 0.9 mm, from about 0.1 mm to about 0.8 mm, from about 0.2 mm to about 0.7 mm, from about 0.3 mm to about 0.6 mm, from about 0.4 mm to about 0.5 mm, or any range or subrange therebetween. In aspects, the TIR of the solid-state electrolyte sheet 103 over a distance of 25 mm can be within one or more of the ranges discussed above. In aspects, the TIR of the solid-state electrolyte sheet 103 over a distance of 50 mm can be within one or more of the ranges discussed above. In aspects, the TIR of the solid-state electrolyte sheet 103 over a distance of 100 mm can be within one or more of the ranges discussed above. In aspects, the TIR of the solid-state electrolyte sheet 103 over a distance of 150 mm can be within one or more of the ranges discussed above. In aspects, the TIR of the solid-state electrolyte sheet 103 over a distance of 170 mm can be within one or more of the ranges discussed above.

Throughout the disclosure, a curvature of the solid-state electrolyte sheet is characterized in terms of optical power (in units of diopters (D)). As with TIR, curvature is calculated using measurements within 1 mm (exclusive) of one another with the measurements taken from the surface profile described above. The curvature reported here is the average (e.g., mean) of all the curvatures calculated for a surface of the solid-state electrolyte sheet. In aspects, the curvature of the solid-state electrolyte sheet 103 can be about 12 D or less, about 10 D or less, about 8 D or less, about 7 D or less, about 6 D or less, about 5 D or less, about 4 D or less, about 3.5 D or less, about 3 D or less, about 2.5 D or less, about 2 D or less, about 0.1 D or more, about 0.5 D or more, about 1 D or more, about 2 D or more, about 2.5 D or more, about 3 D or more, about 4 D or more, or about 5 D or more. In aspects, the curvature of the solid-state electrolyte sheet 103 can be in a range from about 0.1 D to about 12 D, from about 0.1 D to about 10 D, from about 0.5 D to about 8 D, from about 0.5 D to about 7 D, from about 1 D to about 6 D, from about 1 D to about 5 D, from about 2 D to about 4 D, from about 2 D to about 3.5 D, from about 2.5 D to about 3 D, or any range or subrange therebetween.

The ionic conductivity of the solid-state electrolyte sheet 103 is a quantification of the ability of the solid-state electrolyte sheet to transport ions (e.g., oxygen ions) between the oxygen electrode and the fuel electrode or vice versa. Throughout the disclosure, the ionic conductivity is measured at a predetermined temperature (e.g., 800° C., 850° C., 900° C., 950° C.) using a 4-point probe. The 4-point probe comprises a pair of current probes and a pair of voltage probes arranged on a common surface of the solid-state electrolyte sheet such that the pair of voltage probes are separated by a distance of 21 mm, the current probes bracket the pair of voltage probes (i.e., are positioned outside of the distance between the pair of voltage probes), and the probes are attached to the common surface of the solid-state electrolyte sheet using platinum paste with a thickness of 40 μm and a width of 5 mm in the direction that the distance between the pair of voltage probes is measured. Current is passed between the pair of current probes and the change in voltage detected by the pair of voltage probes is monitored. Based on these measurements, ionic conductivity is calculated. Examples 1-24 demonstrate an unexpected benefit of increased ionic conductivity beyond that reported in the prior art under similar conditions. Without wishing to be bound by theory, it is believed that the closed porosity, small average grain size, small maximum grain size, and/or low porosity (e.g., formed as a result of the methods of the present disclosure) contribute to the unexpectedly high ionic conductivity.

In aspects, an ionic conductivity of the solid-state electrolyte sheet 103 at 800° C. can be about 6.5 Siemens per centimeter (S/cm) or more, about 6.6 S/cm or more, about 6.7 S/cm or more, about 6.8 S/cm or more, about 6.9 S/cm or more, about 7.0 S/cm or more, about 7.1 S/cm or more, about 10.0 S/cm or less, about 8.0 S/cm or less, about 7.5 S/cm or less, about 7.3 S/cm or less, about 7.2 S/cm or less, about 7.1 S/cm or less, or about 7.0 S/cm or less. In aspects, an ionic conductivity of the solid-state electrolyte sheet 103 at 800° C. can be in a range from about 6.5 S/cm to about 10.0 S/cm, from about 6.6 S/cm to about 8.0 S/cm, from about 6.7 S/cm to about 7.5 S/cm, from about 6.8 S/cm to about 7.3 S/cm, from about 6.9 S/cm to about 7.2 S/cm, from about 7.0 S/cm to about 7.1 S/cm, or any range or subrange therebetween. As demonstrated below for Examples 1-24, ionic conductivity at 800° C. of greater than 6.5 S/cm (e.g., from 6.7 S/cm to 7.1 S/cm) have been achieved.

In aspects, an ionic conductivity of the solid-state electrolyte sheet 103 at 850° C. can be about 9.5 Siemens per centimeter (S/cm) or more, about 9.6 S/cm or more, about 9.7 S/cm or more, about 9.8 S/cm or more, about 9.9 S/cm or more, about 10.0 S/cm or more, about 10.1 S/cm or more, about 10.2 S/cm or more, about 10.3 S/cm or more, about 10.4 S/cm or more, about 12.0 S/cm or less, about 11.0 S/cm or less, about 10.7 S/cm or less, about 10.5 S/cm or less, about 10.4 S/cm or less, about 10.3 S/cm or less, about 10.2 S/cm or less, about 10.1 S/cm or less, or about 10.0 S/cm or less. In aspects, an ionic conductivity of the solid-state electrolyte sheet 103 at 850° C. can be in a range from about 9.5 S/cm to about 12.0 S/cm, from about 9.6 S/cm to about 11.0 S/cm, from about 9.7 to about 10.7 S/cm, from about 9.8 S/cm to about 10.5 S/cm, from about 9.9 S/cm to about 10.4 S/cm, from about 10.0 S/cm to about 10.3 S/cm, from about 10.1 S/cm to about 10.2 S/cm, or any range or subrange therebetween. As demonstrated below for Examples 1-24, ionic conductivity at 850° C. of greater than 9.5 S/cm (e.g., from 9.8 S/cm to 10.1 S/cm) have been achieved.

In aspects, an ionic conductivity of the solid-state electrolyte sheet 103 at 900° C. can be about 13.0 S/cm or more, about 13.2 S/cm or more, about 13.4 S/cm or more, about 13.5 S/cm or more, about 13.6 S/cm or more, about 13.7 S/cm or more, about 13.8 S/cm or more, about 13.9 S/cm or more, about 14.0 S/cm or more, about 14.1 S/cm or more, about 14.2 S/cm or more, about 14.3 S/cm or more, about 14.4 S/cm or more, about 14.5 S/cm or more, about 16.0 S/cm or less, about 15.5 S/cm or less, about 15.0 S/cm or less, about 14.8 S/cm or less, about 14.7 S/cm or less, about 14.6 S/cm or less, about 14.5 S/cm or less, about 14.4 S/cm or less, about 14.3 S/cm or less, about 14.2 S/cm or less, or about 14.1 S/cm or less. In aspects, an ionic conductivity of the solid-state electrolyte sheet 103 at 900° C. can be in a range from about 13.0 S/cm to about 16.0 S/cm, from about 13.2 S/cm to about 15.5 S/cm, from about 13.4 S/cm to about 15.0 S/cm, from about 13.5 S/cm to about 14.8 S/cm, from about 13.6 S/cm to about 14.7 S/cm, from about 13.7 S/cm to about 14.6 S/cm, from about 13.8 S/cm to about 14.5 S/cm, from about 13.9 S/cm to about 14.4 S/cm, from about 14.0 S/cm to about 14.3 S/cm, from about 14.1 S/cm to about 14.2 S/cm, or any range or subrange therebetween. As demonstrated below for Examples 1-24, ionic conductivity at 900° C. of greater than 13.2 S/cm (e.g., from 13.5 S/cm to 14.1 S/cm) have been achieved.

In aspects, an ionic conductivity of the solid-state electrolyte sheet 103 at 950° C. can be about 18.0 S/cm or more, about 18.2 S/cm or more, about 1.4 S/cm or more, about 18.5 S/cm or more, about 18.6 S/cm or more, about 18.7 S/cm or more, about 18.8 S/cm or more, about 18.9 S/cm or more, about 19.0 S/cm or more, about 19.1 S/cm or more, about 19.2 S/cm or more, about 19.3 S/cm or more, about 19.4 S/cm or more, about 19.5 S/cm or more, about 22.0 S/cm or less, about 21.0 S/cm or less, about 20.5 S/cm or less, about 20.2 S/cm or less, about 20.0 S/cm or less, about 19.8 S/cm or less, about 19.7 S/cm or less, about 19.6 S/cm or less, about 19.5 S/cm or less, about 19.4 S/cm or less, or about 19.3 S/cm or less. In aspects, an ionic conductivity of the solid-state electrolyte sheet 103 at 950° C. can be in a range from about 18.0 S/cm to about 22.0 S/cm, from about 18.2 S/cm to about 21.0 S/cm, from about 18.4 S/cm to about 20.5 S/cm, from about 18.5 S/cm to about 20.2 S/cm, from about 18.6 S/cm to about 20.0 S/cm, from about 18.7 S/cm to about 19.8 S/cm, from about 18.8 S/cm to about 19.7 S/cm, from about 18.9 S/cm to about 19.6 S/cm, from about 19.0 S/cm to about 19.5 S/cm, from about 19.1 S/cm to about 19.4 S/cm, from about 19.2 S/cm to about 19.3 S/cm, or any range or subrange therebetween. As demonstrated below for Examples 1-24, ionic conductivity at 950° C. of greater than 18.0 S/cm (e.g., from 18.5 S/cm to 19.3 S/cm) have been achieved.

As used herein, “interfacial resistance” is measured using electrical impedance spectroscopy (EIS) at 850° C. for frequencies from 0.1 Hertz (Hz) to 1 MegaHertz (MHz). Unless otherwise indicated, EIS was measured using an impedance analyzer at 850° C. A Nyquist plot is constructed with the real component of impedance (Z′ measured in (Ω cm²) on a horizontal axis and the imaginary component of impedance (Z″ measured in (Ω cm²) on a vertical axis. Throughout the disclosure, “interfacial resistance” is defined as the difference between the real components of the impedance for the end-points of an arc shape in EIS results (i.e., Nyquist plot), where the higher end-point is taken as an inflection point in the impedance results. For determining “interfacial resistance”, a pair of platinum electrodes sandwich the solid-state electrolyte sheet.

Throughout the disclosure, “edge strength” is measured in Two-Point Bend Test as described in the Society for Information Display (SID) 2011 Digest, pages 652-654, in a paper entitled “Two Point Bending of Thin Glass Substrate” by S. T. Gulati, J. Westbrook, S. Carley, H. Vepakomma, and T. Ono. As described in that document as applied to a solid-state electrolyte sheet, the solid-state electrolyte sheet is placed between a pair of parallel rigid stainless-steel plates of a parallel plate apparatus such that the second major surface 107 of the solid-state electrolyte sheet contacts each plate, and the distance between parallel is decreased until the substrate fails at a parallel plate distance (D). The edge strength σ is calculated as σ=1.198 Et/(D−t), where E is the elastic modulus of the solid-state electrolyte sheet and tis the thickness 109 of the solid-state electrolyte sheet. During the Two Point Bend test, the environment was controlled at 50% relative humidity and 25° C., and the parallel plate distance was decreased at a rate of 50 μm/second. As used herein, the terms “fail,” “failure” and the like refer to breakage, destruction, delamination, or crack propagation. Throughout the disclosure, the “B10 edge strength” of the substrate is the mean stress of failure of the substrate where 10% of the samples are expected to fail, and the “median edge strength” of the substrate is the mean stress of failure of the substrate where 50% of the samples are expected to fail. Unless otherwise indicated, “edge strength” refers to the B10 edge strength is measured in the Two-Point Bend Test as described above in this paragraph. In aspects, an edge strength of the solid-state electrolyte sheet 103 can be about 300 MegaPascals (MPa) or more, about 350 MPa or more, about 400 MPa or more, about 450 MPa or more about 500 MPa or more, about 530 MPa or more, about 540 MPa or more, about 550 MPa or more, about 560 MPa or more, about 570 MPa or more, about 580 MPa or more, about 600 MPa or more, about 650 MPa or more, about 700 MPa or more, about 800 MPa or more, about 900 MPa or more, about 1200 MPa or less, about 1100 MPa or less, about 1000 MPa or less, about 900 MPa or less, about 850 MPa or less, 800 MPa or less, about 750 MPa or less, about 700 MPa or less, about 650 MPa or less, about 600 MPa or less, about 580 MPa or less, about 560 MPa or less, about 550 MPa or less, or about 500 MPa or less. In aspects, an edge strength of the solid-state electrolyte sheet 103 can be in a range from about 300 MPa to about 1200 MPa, from about 350 MPa to about 1200 MPa, from about 400 MPa to about 1200 MPa, from about 450 MPa to about 1200 MPa, from about 500 MPa to about 1200 MPa, from about 530 MPa to about 1100 MPa, from about 540 MPa to about 1000 MPa, from about 550 MPa to about 900 MPa, from about 560 MPa to about 850 MPa, from about 570 MPa to about 800 MPa, from about 580 MPa to about 750 MPa, from about 600 MPa to about 700 MPa, or any range or subrange therebetween.

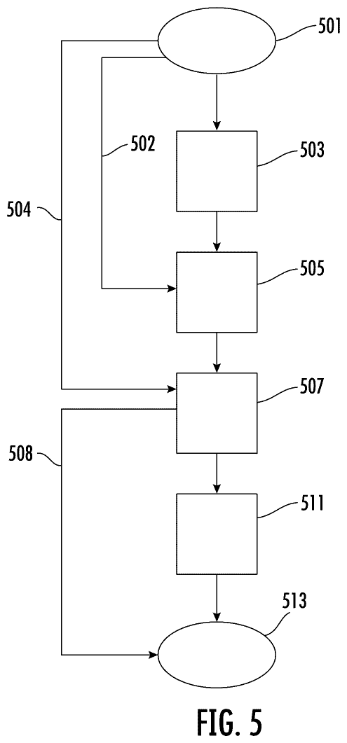

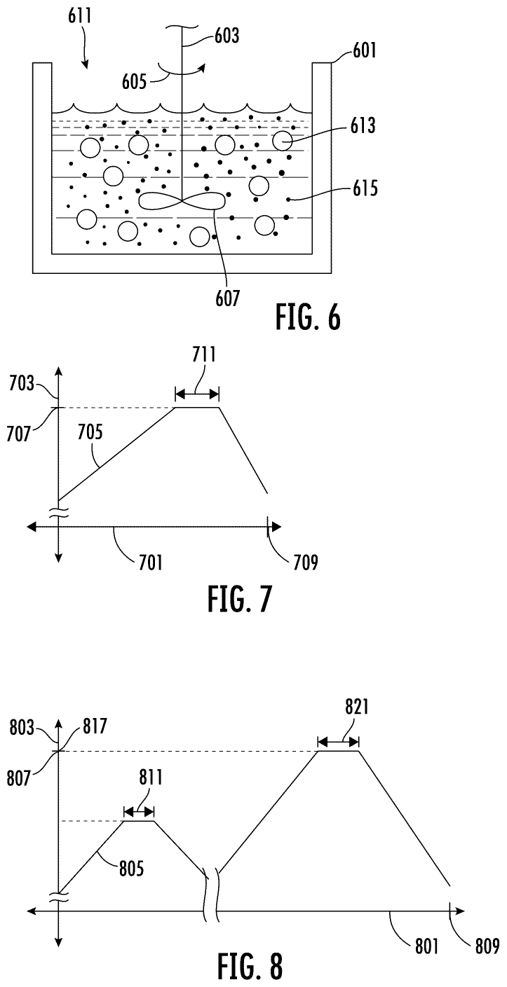

Aspects of methods of making a solid-state electrolyte sheet, a solid oxide electrolyzer cell, and/or a solid oxide fuel cell in accordance with the aspects of the present disclosure will now be discussed with reference to the flow chart shown in FIG. 5 and example method steps illustrated in FIGS. 6-9.

In aspects, as shown in FIG. 5, methods can begin at step 501. In aspects, step 501 can comprise providing or forming a scandia-stabilized zirconia. For example, scandia-stabilized zirconia can be provided by purchase or the scandia-stabilized zirconia can comprise melting raw materials, cooling the melt to form a glass, and then heating the glass to form scandia-stabilized zirconia. In aspects, step 501 can additionally comprise providing materials for forming a green tape, for example, a solvent, a binder, a dispersant, and/or a protic base that are discussed more in the following steps. Alternatively, in aspects, step 501 can comprise forming or otherwise providing a green tape comprising scandia-stabilized zirconia. The scandia-stabilized zirconia (either as a raw material or in a green tape) can comprise scandia within one or more of the corresponding ranges discussed above.

In aspects, after step 501 as shown in FIG. 5, methods can proceed to step 503 comprising forming a slip. In aspects, as shown in FIG. 6, step 503 can comprise mixing raw materials (e.g., scandia-stabilized zirconia 613 and/or binder 615) to form a slip 611. For example, as shown, raw materials including scandia-stabilized zirconia 613 and/or binder 615 can be mixed with a solvent (and optionally a dispersant, a defoamer, a plasticizer, and/or a protic base) in a container 601 using a blade 607 that is rotated (as shown by arrow 605) about a shaft 603. In aspects, the scandia-stabilized zirconia 613 can be added after the other materials and/or the scandia-stabilized zirconia 613 can be added as a series of batches, for example, to increase a dispersion (e.g., homogeneity) of the materials in the slip 611. In aspects, an amount of scandia-stabilized zirconia in the slip 611 or the cast green tape (as a wt % of the total slip or green tape, respectively) can be about 55 wt % or more, about 58 wt % or more, about 60 wt % or more, about 62 wt % or more, about 64 wt % or more, about 65 wt % or more, about 66 wt % or more, about 67 wt % or more, about 70 wt % or less, about 69 wt % or less, about 68 wt % or less, about 67 wt % or less, about 66 wt % or less, about 65 wt % or less, about 63 wt % or less, or about 60 wt % or less. In aspects, an amount of scandia-stabilized zirconia in the slip 611 or the cast green tape (as a wt % of the total slip or green tape, respectively) can be in a range from about 55 wt % to about 70 wt %, from about 60 wt % to about 70 wt %, from about 62 wt % to about 69 wt %, from about 63 wt % to about 68 wt %, from about 64 wt % to about 67 wt %, from about 65 wt % to about 66 wt %, or any range or subrange therebetween. In aspects, preferred ranges for the amount of the scandia-stabilized zirconia can be from about 55 wt % to about 70 wt %, from about 63 wt % to about 68 wt %, or from about 64 wt % to about 67 wt %, or any range or subrange therebetween.

In aspects, the scandia-stabilized zirconia used in the slip 611 (e.g., added to the mixture in step 503 to form the slip 611) can comprise particles with a purity of 95% or more, 97% or more, 98% or more, 99.0% or more, 99.5% or more, or 99.7% or more. For example, the scandia-stabilized zirconia used in the slip 611 can comprise 0.1 mol % or less, 0.05 mol % or less, 0.01 mol % or less, or be free of alumina. As used herein, the “specific surface area” is measured in accordance with ATM C1069-09 (2014). In further aspects, the scandia-stabilized zirconia used in the slip 611 (e.g., added to the mixture in step 503 to form the slip 611) can comprise a specific surface area of 10 m²/g or less, 8 m²/g or less, 7 m²/g or less, 3 m²/g or more, 5 m²/g or more, or 6 m²/g or more, for example, in a range from 3 m²/g to 10 m²/g, from 5 m²/g to 8 m²/g, from 6 m²/g to 8 m²/g, or any range or subrange therebetween. As used herein, a particle size distribution (e.g., d10, d50 or median, and d90) is determined in accordance with ASTM D1214-10 (2020). In further aspects, a median particle size (i.e., d50) of the scandia-stabilized zirconia used in the slip can be about 0.3 μm or more, about 0.4 μm or more, about 0.5 μm or more, about 0.6 μm or more, about 1.0 μm or less, about 0.9 μm or less, about 0.8 μm or less, about 0.7 μm or less, about 0.6 μm or less, or about 0.5 μm or less. In further aspects, a median particle size (i.e., d50) of the scandia-stabilized zirconia used in the slip can be in a range from about 0.3 μm to about 1.0 μm, from about 0.3 μm to about 0.9 μm, from about 0.4 μm to about 0.8 μm, from about 0.5 μm to about 0.7 μm, or any range or subrange therebetween. In further aspects, a d10 particle size of the scandia-stabilized zirconia used in the slip can be about 0.1 μm or more, about 0.2 μm or more, about 0.3 μm or more, about 0.5 μm or less, about 0.4 μm or less, or about 0.3 μm or less, for example, in a range from about 0.1 μm to about 0.4 μm, from about 0.2 μm to about 0.3 μm, or any range or subrange therebetween. In further aspects, a d90 particle size of the scandia-stabilized zirconia used in the slip can be about 4.0 μm or less, about 3.7 μm or less, about 3.5 μm or less, about 3.2 μm or less, about 3.0 μm or less, about 2.0 μm or more, about 2.5 μm or more, or about 3.0 μm or more, for example, in a range from about 2.0 μm to about 4.0 μm, from about 2.5 μm to about 3.7 μm, from about 3.0 μm to about 3.5 μm, or any range or subrange therebetween. In further aspects, a spread between a d10 particle size and a d90 particle size of the scandia-stabilized zirconia used in the slip can be about 3.5 μm or less, about 3.2 μm or less, about 3.0 μm or less, about 2.8 μm or less, about 2.5 μm or less, about 2.2 μm or less, about 2.0 μm or less, about 1.0 μm or more, about 1.5 μm or more, about 2.0 μm or more, or about 2.2 μm or more, for example, in a range from about 1.0 μm to about 3.5 μm, from about 1.5 μm to about 3.2 μm, from about 2.0 μm to about 3.0 μm, from about 2.2 μm to about 2.8 μm, or any range or subrange therebetween.

The binder 615 can comprise one or more polymeric materials. The binder can provide mechanical strength to the green tape before and/or during the sintering. In aspects, the binder can be a polymer compatible with the solvent, for example, an acrylic polymer, a methacrylate polymer, a carbonate-containing polymer, a vinyl acetate resin, a maleic acid polymer, a vinyl butyral resin, a vinyl formal resin, a vinyl alcohol resin, a cellulose resin, or copolymers or combinations thereof. An exemplary aspect of the binder is an acrylic polymer system, which are commercially available from numerous polymer and casting companies. In aspects, an amount of the binder in the slip 611 or the cast green tape (as a wt % of the total slip or green tape, respectively) can be about 10 wt % or more, about 11 wt % or more, about 12 wt % or more, about 12.5 wt % or more, about 13 wt % or more, 13 wt % or more, about 13.5 wt % or more, about 15 wt % or less, about 14.5 wt % or less, about 14 wt % or less, about 13.5 wt % or less, about 13 wt % or less, or about 12.5 wt % or less. In aspects, an amount of the binder in the slip 611 or the cast green tape (as a wt % of the total slip or green tape, respectively) can be in a range from about 10 wt % to about 15 wt %, from about 11 wt % to about 14.5 wt %, from about 12 wt % to about 14 wt %, from about 12.5 wt % to about 14 wt %, from about 13 wt % to about 13.5 wt % or any range or subrange therebetween. In aspects, preferred ranges for the amount of the binder can be from about 10 wt % to about 15 wt %, from about 12 wt % to about 14.5 wt %, or from about 13 wt % to about 14 wt %, or any range or subrange therebetween.

In aspects, the solvent can be a polar protic solvent, for example water or alcohols (e.g., methanol, ethanol, isopropyl alcohol, acetic acid), or a polar aprotic solvent, for example a ketone (e.g., methyl ethyl ketone, acetone), N,N-dimethylformamide, dimethyl sulfoxide, dimethyl sulfoxide, dimethyl carbonate, methyl ethyl ketone, toluene, anisole, dioxolane, methoxy propyl acetate, or combinations thereof. An exemplary aspect of the solvent is water. In aspects, an amount of the solvent in the slip 611 or the cast green tape (as a wt % of the total slip or green tape, respectively, before the solvent is evaporated) can be about 10 wt % or more, 15 wt % or more, about 16 wt % or more, about 17 wt % or more, about 18 wt % or more, about 19 wt % or more, about 20 wt % or more, about 22 wt % or more, about 30 wt % or less, about 25 wt % or less, about 23 wt % or less, about 22 wt % or less, about 21 wt % or less, about 20 wt % or less, or about 19 wt % or less. In aspects, an amount of the solvent in the slip 611 or the cast green tape (as a wt % of the total slip or green tape, respectively, before the solvent is evaporated) can be in a range from about 10 wt % to about 30 wt %, from about 15 wt % to about 25 wt %, from about 16 wt % to about 23 wt %, from about 17 wt % to about 22 wt %, from about 18 wt % to about 21 wt %, from about 19 wt % to about 20 wt %, or any range or subrange therebetween.

As used herein, a “dispersant” refers to a material that improves a separation of particles, improves a uniformity of a distribution of particles, decreases particle aggregation, and/or reduces settling of particles. In aspects, the dispersant can comprise a fish oil or commercial dispersants, for example, the Hypermer line of dispersants (available from Croda Energy Technologies). In aspects, an amount of the dispersant in the slip 611 or the cast green tape (as a wt % of the total slip or green tape, respectively) can be about 0 wt % or more, about 0.1 wt % or more, about 0.2 wt % or more, about 0.5 wt % or more, about 0.7 wt % or more, about 1.0 wt % or more, about 1.2 wt % or more, about 1.5 wt % or more, about 5 wt % or less, about 4 wt % or less, about 3 wt % or less, about 2 wt % or less, about 1.5 wt % or less, or about 1 wt % or less. In aspects, an amount of the dispersant in the slip 611 or the cast green tape (as a wt % of the total slip or green tape, respectively, before the solvent is evaporated) can be in a range from about 0 wt % to about 5 wt %, from about 0.1 wt % to about 5 wt %, from about 0.2 wt % to about 4 wt %, from about 0.5 wt % to about 3 wt %, from about 0.7 wt % to about 2 wt %, from about 1 wt % to about 1.5 wt %, or any range or subrange therebetween. Providing a dispersant can facilitate a good dispersion of scandia-stabilized zirconia particles in the solvent with few or no aggregates.

As noted above, additional components in the slip 611 can include a defoamer and/or a plasticizer. For example, plasticizers can include a dibutyl carboxylic acid ester. Exemplary aspects of plasticizers include dibutyl phthalate, dibutyl adipate, dibutyl maleate, poly(ethylene glycol), and combinations thereof. In further aspects, the viscosity modifier can comprise dibutyl phthalate. Amounts of the additional components can be within one or more of the range discussed above in the previous paragraph for the amount of the dispersant. Alternatively, in aspects, the slip 611 can be free from a defoamer, a plasticizer, and/or other additional components.

Without wishing to be bound by theory, a protic base can passivate and/or form a hydroxide compound at a surface of the scandia-stabilized zirconia. In aspects, the protic base can be an alkali hydroxide (e.g., NaOH, KOH) and/or ammonia. An exemplary aspect of the protic base is ammonia. In aspects, an amount of the protic base (or reaction products thereof) in the slip 611 or the cast green tape (as a wt % of the total slip or green tape, respectively) can be about 0 wt % or more, about 0.1 wt % or more, about 0.2 wt % or more, about 0.5 wt % or more, about 0.7 wt % or more, about 1.0 wt % or more, about 1.2 wt % or more, about 1.5 wt % or more, about 5 wt % or less, about 4 wt % or less, about 3 wt % or less, about 2 wt % or less, about 1.5 wt % or less, or about 1 wt % or less. In aspects, an amount of the protic base (or reaction products thereof) in the slip 611 or the cast green tape (as a wt % of the total slip or green tape, respectively, before the solvent is evaporated) can be in a range from about 0 wt % to about 5 wt %, from about 0.1 wt % to about 5 wt %, from about 0.2 wt % to about 4 wt %, from about 0.5 wt % to about 3 wt %, from about 0.7 wt % to about 2 wt %, from about 1 wt % to about 1.5 wt %, or any range or subrange therebetween.

In aspects, although not shown, step 503 can further comprise deairing the slip. In further aspects, deairing the slip can comprise subjecting the slip to a reduced pressure environment for a predetermined period of time. As used herein, a “reduced pressure environment” has an absolute pressure of less than 80 kiloPascals (kPa). In further aspects, the reduced pressure environment can comprise an absolute pressure in a range from about 1 kPa to about 80 kPa, from about 5 kPa to about 50 kPa, from about 10 kPa to about 30 kPa, or any range or subrange therebetween. In further aspects, the predetermined period of time can be about 1 minute or more, about 5 minutes or more, about 30 minutes or less, or about 10 minutes or less, for example, from about 1 minute to about 30 minutes, from about 5 minutes to about 10 minutes, or any range or subrange therebetween.

After step 501 or 503, as shown in FIG. 5, methods can proceed to step 505 comprising casting the slip 611 to form a green tape with an initial thickness. In further aspects, the initial thickness can be within one or more of the ranges discussed above for the thickness 109. In further aspects, the initial thickness can be greater than the thickness 109 of the resulting solid-state electrolyte sheet 103 by from about 1% to about 50%, from about 2% to about 40%, from about 5% to about 30%, from about 7% to about 20%, from about 10% to about 15%, or any range or subrange therebetween. In further aspects, casting can comprise using a doctor blade or other methods known in the art.

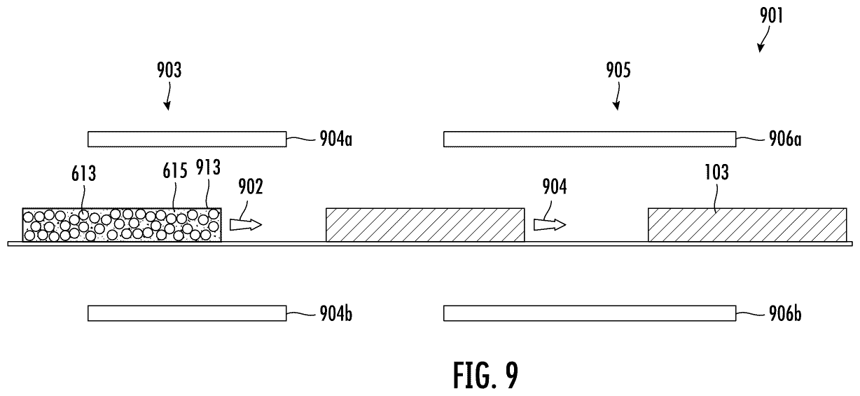

After step 501 or 505, as shown in FIG. 5, methods can proceed to step 507 comprising firing the green tape to form the solid-state electrolyte sheet 103. In aspects, as shown in FIG. 9, step 507 comprises heating a green tape 913 (comprising the scandia-stabilized zirconia 613 and the binder 615) with one or more heaters 904a and/or 904b (e.g., in a first oven 903 as part of a firing apparatus 901). In further aspects, as shown, the green tape can be conveyed through the first oven 903 (e.g., one or more heaters 904a and/or 904b) in a direction 902. In even further aspects, the green tape can be conveyed on a setter plate, although long green tapes can be conveyed through using a rollers system spanning a distance greater than the first oven 903. The heating the green tape can remove organic materials (e.g., solvent and/or binder) in the green tape. Additionally, heating the green tape can sinter the scandia-stabilized zirconia in the green tape to form the solid-state electrolyte sheet 103.

In aspects, the firing can comprise heating the green tape at a maximum temperature of 1650° C. or less, about 1625° C. or less, about 1600° C. or less, about 1575° C. or less, about 1550° C. or less, about 1525° C. or less, about 1500° C. or less, about 1450° C. or less, or about 1400° C. or less. In aspects, the firing can comprise heating the green tape at a maximum temperature in a range from about 1100° C. to about 1650° C., from 1200° C. to about 1600° C., from about 1300° C. to about 1575° C., from about 1350° C. to about 1550° C., from about 1375° C. to about 1500° C., from about 1400° C. to about 1475° C., from about 1425° C. to about 1450° C., or any range or subrange therebetween. Throughout the disclosure, heating “at” a specified temperature means that the heating provided from the local environment (e.g., heaters, oven) are maintained to provide a local temperature at the specified temperature. Providing a maximum temperature of 1650° C. or less (or 1625° C. or less or 1600° C. or less) can facilitate formation of the microstructure (e.g., grain size, porosity, and/or associated grain size distribution) associated with the increased ionic conductivity of the solid-state electrolyte sheets of the present disclosure.

In aspects, the firing can comprise heating the green tape at temperatures of 600° C. or more (e.g., from 600° C. to the maximum temperature) for 90 minutes or less, 75 minutes or less, 60 minutes or less, 50 minutes or less, 45 minutes or less, 40 minutes or less, 35 minutes or less, 30 minutes or less, 25 minutes or less, 20 minutes or less, 15 minutes or less, 10 minutes or less, 2 minutes or more, 3 minutes or more, 5 minutes or more, 7 minutes or more, 10 minutes or more, 12 minutes or more, 15 minutes or more, 17 minutes or more, 20 minutes or more, 25 minutes or more, or 30 minutes or more. In aspects, the firing can comprise heating the green tape at temperatures of 600° C. or more (e.g., from 600° C. to the maximum temperature) for a period of time in a range from 2 minutes to 90 minutes, from 3 minutes to 75 minutes, from 5 minutes to 60 minutes, from 7 minutes to 50 minutes, from 10 minutes to 45 minutes, from 12 minutes to 40 minutes, from 15 minutes to 35 minutes, from 17 minutes to 30 minutes, from 20 minutes to 25 minutes, or any range or subrange therebetween. Heating the green tape (at temperatures of 600° C. or more) for 90 minutes or less (e.g., from 5 minutes to 60 minutes) can reduce resource requirements and/or increase a throughput of the method.

In aspects, the firing can comprise exposing the green tape to a heating temperature profile, which can resemble the temperature profiles 705 or 805 schematically shown in FIGS. 7-8. In FIGS. 7-8, the horizontal axis 701 or 801 (e.g., x-axis) corresponds to time and the vertical axis 703 and 803 (e.g., y-axis) corresponds to a temperature that the green tape is heated at. For example, the temperature profiles 705 or 805 shown in FIGS. 7-8 can be achieved by conveying the green tape through an oven (e.g., lehr) with spatially distinct zones maintained at various temperatures to approximate the temperature profile. Consequently, it is to be understood that temperature profiles may be a series of temperature steps rather than the linear temperature ramps shown in FIGS. 7-8. As shown in FIGS. 7-8, the period of time for heating the green tape at temperatures of 600° C. or more discussed in the previous paragraph can correspond to time 807 or 809.

Throughout the disclosure, a “firing step” refers to heating at temperatures greater than 600° C. that increases by more than 200° C. to reach a local maximum temperature before decreasing by more than 200° C. In further aspects, as shown in FIG. 7, the temperature profile 705 (e.g., firing) can comprise a single firing step to the maximum temperature 707. For example, a single firing step can remove organic materials and sinter the green tape, although organic materials can be removed at a temperature lower than 600° C. before the single firing step in further aspects. Alternatively, in further aspects as shown in FIG. 8, the temperature profile 805 (e.g., firing) can comprise a plurality of firing steps (i.e., two or more firing steps). For example, as shown in FIG. 8, the temperature profile 805 can have two firing steps, for example, heating to a local maximum temperature 811 in a first firing step followed by heating to the maximum temperature 821 in a second firing step. As shown in FIG. 9, after heating the green body 913 in the first oven 903 (e.g., heaters 904a and/or 904b) corresponding to a first firing step (as indicated by the green body being conveyed therethrough with arrow 902), the resulting article can be further heated in a second oven 905 (e.g., heaters 906a and/or 906b) in a second firing step (as indicated by arrow 904).

In further aspects, with reference to FIGS. 7-8, a maximum period of time that the maximum temperature 711 or 821 (as part of a temperature ramp to the maximum temperature in a firing step) that the green tape is exposed to can be 20 minutes or less, 17 minutes or less, 15 minutes or less, 12 minutes or less, 10 minutes or less, 7 minutes or less, 5 minutes or less, or 3 minutes or less. In further aspects, with reference to FIGS. 7-8, a maximum period of time that the maximum temperature 711 or 821 (as part of a temperature ramp to the maximum temperature in a firing step) that the green tape is exposed to can be in a range from 10 seconds to 20 minutes, from 20 seconds to 17 minutes, from 30 minutes to 15 minutes, from 45 seconds to 12 minutes, from 1 minute to 10 minutes, from 2 minutes to 7 minutes, from 3 minutes to 5 minutes, or any range or subrange therebetween. In further aspects, with reference to FIGS. 7-8, a maximum period of time that the maximum temperature 711 or 821 (as part of a temperature ramp to the maximum temperature in a firing step), as a percentage of the period of time in the firing step at temperatures of 600° C. or more, that the green tape is exposed to can be about 1% or more, about 3% or more, about 5% or more, about 7% or more, about 10% or more, 12% or more, 15% or more, 20% or less, 17% or less, 15% or less, 12% or less, 10% or less, 7% or less, or 5% or less. In further aspects, with reference to FIGS. 7-8, a maximum period of time that the maximum temperature 711 or 821 (as part of a temperature ramp to the maximum temperature in a firing step), as a percentage of the period of time in the firing step at temperatures of 600° C. or more, that the green tape is exposed to can be in a range from about 1% to about 20%, from about 3% to about 20%, from about 5% to about 20%, from about 7% to about 17%, from about 10% to about 15%, or any range or subrange therebetween. In further aspects, a maximum total period of time that maximum temperatures 711 or 811 and 821 (either in absolute time or as a percentage of the period of time in the firing step at temperatures of 600° C. or more) can be within one or more of the corresponding ranges discussed above in this paragraph for the maximum period of time at the maximum temperature. Providing a maximum period of time at the maximum temperature from 10 seconds to 20 minutes or from 5% to 20% of the period of time in the firing step at temperatures of 600° C. or more can reduce resource requirements (e.g., energy) of the method.

In aspects, although not shown, the solid-state electrolyte sheet formed in step 507 can be wound (e.g., rolled) on a spool, for example, for storage and/or transport. The thin form factor (e.g., thickness) and high edge strength enable the solid-state electrolyte sheet to be wound on the spool. In further aspects, the solid-state electrolyte sheet can be unwound from the spool and cut to a predetermined size based on the resulting solid oxide fuel cell and/or a solid oxide electrolyzer cell that it is to be incorporated into, for example, in step 511.

In aspects after step 507, as shown in FIG. 5, methods can proceed to step 511 comprising assembling the solid-state electrolyte sheet into a solid oxide fuel cell and/or a solid oxide electrolyzer cell (e.g., see FIGS. 1-2). In further aspects, step 507 can comprise disposing an oxygen electrode over the first major surface of the solid-state electrolyte sheet and a fuel electrode over the second major surface opposite the first major surface. In further aspects, with reference to FIG. 1, step 507 can comprise disposing the assembly of the oxygen electrode 113, the solid-state electrolyte sheet 103, and the fuel electrode 123 in a body 151 including an oxygen-containing region 153 and/or a fuel-containing region 155.

After step 507 or 511, methods can be complete upon reaching step 513. In aspects, methods of making the making the solid-state electrolyte sheet, the solid oxide electrolyzer cell, and/or the solid oxide fuel cell with aspects of the disclosure can proceed along steps 501, 503, 505, 507, 511, and 513 of the flow chart in FIG. 5 sequentially, as discussed above. In aspects, methods can follow arrow 502 from step 501 to step 505, for example, if a slip is already present by the end of step 501. In aspects, methods can follow arrow 504 from step 501 to step 505, for example, if a green tape is already present by the end of step 501. In aspects, methods can follow arrow 508 from step 507 to step 513, for example, if methods are complete at the end of step 507. Any of the above options may be combined to make the solid-state electrolyte sheet, the solid oxide electrolyzer cell, and/or the solid oxide fuel cell with aspects of the disclosure.

### EXAMPLES

Various aspects will be further clarified by the following examples. Comparative Examples comprised yttria-stabilized zirconia with 3 mol % yttria (“YSZ”). Comparative Example CC comprised scandia-stabilized zirconia with 6 mol % scandia not manufactured in accordance with the present disclosure. Examples 1-24 and D-F comprised scandia-stabilized zirconia with 6 mol % scandia that is manufactured in accordance with the present disclosure.

The slip for Examples 1-24 and D-F was prepared by milling a solvent, a binder, a dispersant, a protic base, and a defoamer with YSZ milling media. The 6 mol % scandia-stabilized zirconia comprising a specific surface area of 7.5 m²/g and a median particle size of 0.78 μm was added to this mixture to form the slip in accordance with the present disclosure, as described above. The slip was then deaired for 1 hour under vacuum. The green tape was cast to a thickness of about 50 μm at about 23° C. and about 50% relative humidity. The green tape was fired using the firing profiles detailed in Tables 1 and 4. For Examples 1-24 and D-F, the solvent was water, the binder was an acrylic polymer system, and the protic base was ammonia.

Comparative Examples AA-BB manufactured using the same method as outlined above for Examples 1-24 except that (1) YSZ was used instead of scandia-stabilized zirconia and (2) the composition of the slip in w % was adjusted to have the same vol % of components as Examples 1-24 (due to differences in the density of scandia-stabilized zirconia and YSZ). Comparative Example CC was prepared as reported in Mark R. Terner et al, “On the conductivity degradation and phase stability of solid oxide fuel cell (SOFC) zirconia electrolytes analyzed via XRD”, Solid State Ionics 263 (2014): 180-189.

Table 1 presents the firing profiles for Examples 1-11 and Comparative Examples (Comp. Ex.) AA-BB. As shown, the firing profiles for Examples 1-11 and Comparative Examples AA-BB have two firing steps (e.g., see FIG. 8). The first firing step had a local maximum temperature (max T₁) of from 1380° C. to 1400° C. for from 1 minute to 1.5 minutes with a total heating time for the first firing step of 9 minutes. Examples 1-5 have the same first firing step times and temperatures as one another; likewise, Examples 6-11 have the same first firing step times and temperatures as one another but different from those for Examples 1-5. The second firing step had a maximum temperature (max T₂) of from 1560° C. to 1625° C. for from 0.25 minutes (15 seconds) to 12 minutes with a total heating time for the second firing step of 2.25 minutes (2 minutes and 15 seconds) to 24 minutes. In Examples 1-5 (and Examples 6-11, respectively) the maximum temperature is the same but the time at the maximum temperature decreases going from Example 1 to Example 5 (or from Example 6 to Example 11) and the maximum temperature for Examples 1-6 is different than the maximum temperature for Examples 6-11. As shown in Table 1, the total heating time is from about 11 minutes to about 50 minutes.

TABLE 1
Firing Profiles of Examples 1-11
and Comparative Examples AA-BB

| | Max | Time at | Max | Time at | |
|---|---|---|---|---|---|
| | T₁ | T₁ | T₂ | T₂ | Total Heating |
| | (° C.) | (min) | (° C.) | (min) | Time (min) |
| Comp. Ex. AA | 1400 | 1 | 1566 | 1 | 18 |
| Comp. Ex. BB | 1380 | 1.5 | 1566 | 3 | 33 |
| Example 1 | 1400 | 1 | 1625 | 2 | 27 |
| Example 2 | 1400 | 1 | 1625 | 1 | 18 |
| Example 3 | 1400 | 1 | 1625 | 0.5 | 13.5 |
| Example 4 | 1400 | 1 | 1625 | 0.33 | 12 |
| Example 5 | 1400 | 1 | 1625 | 0.25 | 11.25 |
| Example 6 | 1380 | 1.5 | 1566 | 12 | 82.5 |
| Example 7 | 1380 | 1.5 | 1566 | 6 | 49.5 |
| Example 8 | 1380 | 1.5 | 1566 | 3 | 33 |
| Example 9 | 1380 | 1.5 | 1566 | 1.5 | 24.75 |
| Example 10 | 1380 | 1.5 | 1566 | 1 | 22 |
| Example 11 | 1380 | 1.5 | 1566 | 0.75 | 20.63 |

TABLE 2
Microstructure of Examples 1-11
and Comparative Examples AA-BB

| | Porosity | Min Grain | Mean Grain | Max Grain |
|---|---|---|---|---|
| | (%) | Size (μm) | Size (μm) | Size (μm) |
| Comp. Ex. AA | 0.05 | 0.31 | 0.40 | 0.50 |
| Comp. Ex. BB | 0.09 | 0.31 | 0.39 | 0.50 |
| Example 1 | 0.20 | 1.25 | 2.08 | 4.99 |
| Example 2 | 0.58 | 1.25 | 2.08 | 4.99 |
| Example 3 | 1.30 | 1.25 | 1.55 | 2.49 |
| Example 4 | 2.17 | 1.25 | 1.87 | 2.49 |
| Example 5 | 2.74 | 1.25 | 1.31 | 2.49 |
| Example 6 | 0.22 | 1.00 | 1.56 | 2.49 |
| Example 7 | 0.48 | 1.00 | 1.19 | 1.66 |
| Example 8 | 1.16 | 0.71 | 1.04 | 1.66 |
| Example 9 | 2.08 | 0.83 | 1.03 | 1.66 |
| Example 10 | 3.23 | 0.71 | 0.92 | 1.25 |
| Example 11 | 3.97 | 0.62 | 0.80 | 1.00 |

Table 2 presents properties of the microstructure measured for Comparative Examples AA-BB and Examples 1-11, measured as described above. Compared to Comparative Examples AA-BB with less than 0.1% porosity, Examples 1-11 have higher porosity of from about 0.2% to about 4%. Within Examples 1-11, Examples 1-2 and 6-7 have porosity less than 1% and have the longest heating times (and times at the maximum temperature) of Examples 1-11. Consequently, Table 2 suggests that the porosity decreases as the heating time (and time at the maximum temperature) is increased (e.g., going from Example 5 to Example 1 or from Example 11 to Example 5). This suggests that additional heating time (and time at the maximum temperature) facilitates the consolidation of scandia-stabilized grains, which can decrease porosity in the resulting article.

Compared to Comparative Examples AA-BB with a mean grain size of about 0.40 μm, Examples 1-11 have higher mean grain sizes from 0.8 μm to 2.1 μm. Looking at Examples 6-11, the average grain size increases going from Example 11 to Example 6, suggesting that the mean grain size increases as the heating time (and the time at the maximum temperature) increases. This is consistent with the trend in porosity, where the additional heating time (and time at the maximum temperature) facilitates the consolidation of scandia-stabilized grains and thus larger grains. However, Example 4 does not follow this trend. Also, Examples 1-2 have the same measured mean grain size (and distribution as indicated by the minimum and maximum grain sizes), which suggests that there is no further benefit in grain size (although porosity further decreases) by extending the heating conditions from Example 2 to those in Example 1 (even though the time at the maximum temperature is greater for Examples 6-7 than for Examples 1-5).

Table 2 also reports minimum (“min”) and maximum (“max”) grain sizes that can provide a sense of the grain size distribution (e.g., in combination with the mean grain size). The maximum grain size decreases going from Example 1 to Example 11. Examples 1-2, 3-6, and 7-9 have the same maximum grain size, respectively. Likewise, the minimum grain size decreases from Example 1 to Example (with the exception of Example 9) with Examples 1-5 and 6-7 having the same minimum grain size, respectively. In view of the trends discussed in the previous paragraphs, this is unexpected (especially between Examples 1-5 and Example 6-11) since the lower maximum temperature (max T₂) for Examples 6-11 is lower than that for Examples 1-5. This suggests that slightly longer times (but still less than a total of 60 minutes and a time of less than 20 minutes at the maximum temperature) at a lower maximum temperature can provide decreased grain sizes (e.g., maximum grain size, minimum grain size, and/or mean grain size).

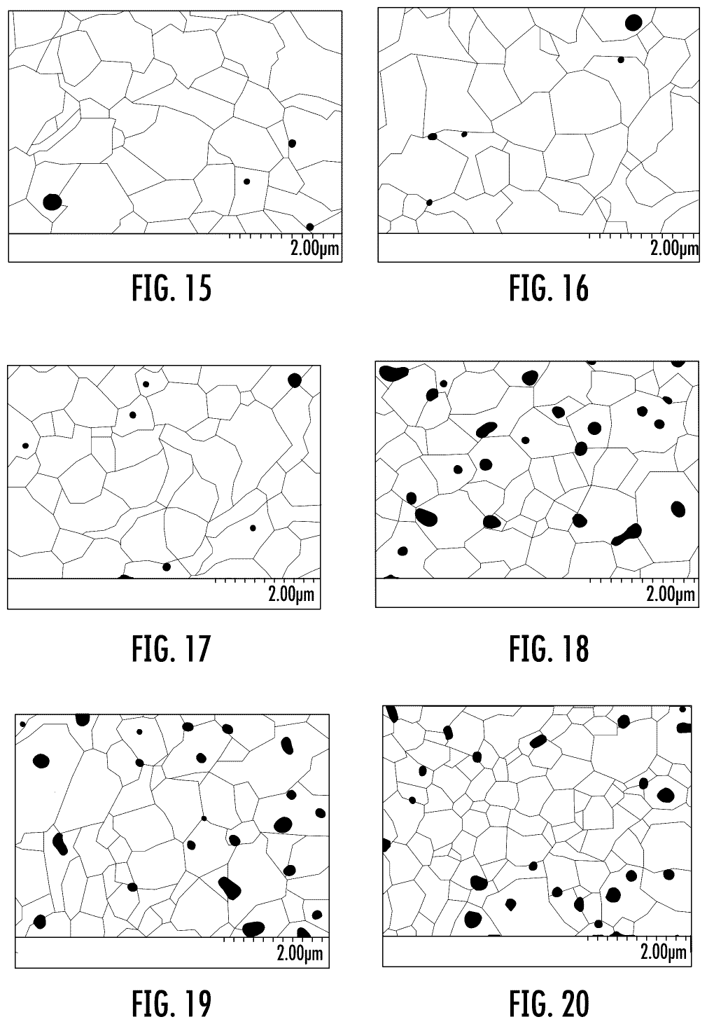

FIGS. 10-14 represent SEM images of cross-sections of Examples 1-5, and FIGS. 15-20 represent SEM images of cross-sections of Examples 6-11. In FIGS. 10-20, the grain boundaries are shown by the lines, and the pores are shown as solid black shapes (to increase reproducibility compared to the experimental grayscale images). As shown in FIGS. 10-12 and 15-17 show all of the pores (or all but one of the pores) being within a grain, which is counted as a closed pore. FIGS. 13-14 and 18-20 have more pores than FIGS. 10-12 and 15-17 consistent with the trend observed in Table 2. Still, a majority of the pores shown in FIGS. 13-14 and 18-20 are within a grain, which is counted a closed pore. Consequently, Examples 1-11 demonstrate a predominantly closed porosity.

FIGS. 25-26 present results of X-ray diffraction (XRD) analysis of Example 6. As discussed above, in FIGS. 25-26, the horizontal axis 2501 or 2601 (e.g., x-axis) corresponds to two theta (20) in degrees) (°, and the vertical axis 2503 or 2603 is a relative intensity of the diffraction peaks that is proportional to a number of detected diffracted X-rays. In FIG. 25, spectrum 2505 shows several diffraction peaks that are all associated with the tetragonal crystal phase. Consequently, spectrum 2505 indicates that greater than 99% (e.g., about 100%) of the crystal phases in the scandia-stabilized zirconia grains is tetragonal. In FIG. 26, additional sampling was performed and the zoomed-in portion of the spectrum 2605 shows two peaks that can be fit using curves centered at the locations shown, where curves 2607a-2607c are associated with the tetragonal crystal phase and curves 2609a-b are associated with a cubic zirconia crystal phase. In combination with the other diffraction peaks (including those outside of the zoomed-in range shown in FIG. 26), a relative amount of the tetragonal crystal phase in the scandia-stabilized zirconia grains is still estimated to be 99% or more.

Table 3 presents ionic conductivity values measured at various temperatures (as indicated by the column labels) as well as the edge strength and curvature-related measurements (e.g., TIR and curvature). As described above, ionic conductivity is measured with the 4-point probe. The ionic conductivity of Examples 1-11 is more than three times greater than the corresponding ionic conductivity of Comparative Examples 1-11 (for measurements compared within each of the temperatures reported in Table 3). This is a notable benefit of adding scandia to zirconia instead of yttria in the YSZ of Comparative Examples AA-BB. Further, compared to the scandia-stabilized zirconia of Comparative Example CC, Examples 1-11 exhibit even higher ionic conductivity at 850° C. (e.g., at least 5% greater than Comparative Example CC with Examples 1, 3, and 6-8 exhibiting ionic conductivity of greater than 10 S/cm—a 10% or more increase relative to Comparative Example CC). At 900° C., the ionic conductivity of Examples 1-11 are greater than the ionic conductivity of Comparative Example CC (e.g., 30% or more, with Examples 3-4, 6-8, and 10 having an ionic conductivity greater than 13.8 S/cm—a 35% or more increase relative to Comparative Example C). Given that Comparative Example CC and Examples 1-11 have the same amount of scandia, this increase in ionic conductivity is unexpected. As discussed above, it is believed that the microstructure (e.g., mean grain size and/or grain size distribution), porosity, and/or closed porosity of Examples 1-11 (and Examples 1-24) facilitate this unexpectedly increased ionic conductivity.

TABLE 3
Ionic Conductivity and Properties of Examples
1-11 and Comparative Examples AA-CC

| Ionic | | | | | Edge | | |
|---|---|---|---|---|---|---|---|
| Conductivity | 800° | 850° | 900° | 950° | Strength | TIR | Curvature |
| (S/cm) | C. | C. | C. | C. | (MPa) | (mm) | (D) |
| Comp. Ex. AA | 1.58 | 2.36 | 3.40 | 4.74 | 1006 | 0.75 | 3.3 |
| Comp. Ex. BB | 1.56 | 2.31 | 3.31 | 4.60 | 1034 | 0.27 | 5.3 |
| Comp. Ex. CC | — | 9.10 | 10.20 | — | — | — | — |
| Example 1 | 7.03 | 10.16 | 14.20 | 19.28 | 572 | 0.75 | 2.8 |
| Example 2 | 6.82 | 9.84 | 13.74 | 18.64 | 555 | 0.87 | 2.9 |
| Example 3 | 6.96 | 10.00 | 13.91 | 18.79 | 513 | 0.79 | 3.2 |
| Example 4 | 6.88 | 9.92 | 13.84 | 18.76 | 383 | 0.86 | 5.8 |
| Example 5 | 6.87 | 9.82 | 13.59 | 18.28 | 321 | 1.05 | 11.5 |
| Example 6 | 6.98 | 10.09 | 14.11 | 19.17 | 551 | 0.49 | 7.6 |
| Example 7 | 6.97 | 10.08 | 14.09 | 19.12 | 541 | 0.56 | 6.8 |
| Example 8 | 6.97 | 10.09 | 14.13 | 19.22 | 475 | 0.44 | 5.9 |
| Example 9 | 6.95 | 9.90 | 13.65 | 18.29 | 460 | 0.32 | 5.2 |
| Example 10 | 6.74 | 9.81 | 13.81 | 18.88 | — | 1.40 | 6.6 |
| Example 11 | 6.89 | 9.88 | 13.59 | 18.50 | — | 2.20 | 6.8 |

As shown in Table 3, the edge strength (measured in the Two-Point Bend Test described above) of Examples 1-9 is less than that of Comparative Examples AA-BB. This is expected since increasing amounts of scandia are associated with decreased edge strength and other mechanical properties. However, Examples 1-3 and 6-7 have edge strength greater than 500 MPa, suggesting that increased heating times are associated with increased edge strength.

As shown in Table 3, curvature-related properties are also reported. Examples 1-4 and 6-9 have a TIR of less than 1 mm (e.g., less than 0.9 mm), which is comparable to or better than the TIR of Comparative Example AA. Similarly, Examples 1-4 and 6-11 have curvature of less than 10 D (e.g., less than 7 D). Further Examples 1-3 have curvature less than that of Comparative Examples AA-BB. Consequently, methods of present disclosure can produce substantially flat solid-state electrolyte sheets.

Table 4 presents the firing profiles for Examples 12-24 and Examples D-F. In contrast to the firing profiles in Table 1, the firing profiles in Table 4 (for Examples 12-24 and Examples D-F) have a single firing step (e.g., see FIG. 7). Further, compared to the firing profiles in Table 1, the maximum temperature of the firing profile in Table 4 is lower. The single firing step had a maximum temperature (Tₘₐₓ) of from 1450° C. to 1500° C. for from 1.5 minutes to 9 minutes with a total heating time for the single firing step of 5.5 minutes to 33 minutes. In Examples 12-19 (and Examples 20-24, respectively) the maximum temperature is the same but the time at the maximum temperature decreases going from Example 12 to Example 15 and from Example 16 to Example 19 (or from Example 20 to Example 22), and the maximum temperature for Examples 12-19 is different than the maximum temperature for Examples 20-24). Compared to Examples 12-15, Examples 16-20 have the same total heating time (respectively) but Examples 16-20 have more time at the maximum temperature than Examples 12-15 (respectively).

TABLE 4
Firing Profiles of Examples 12-24 and C-E

| | Tₘₐₓ | Time at | Total Heating |
|---|---|---|---|
| | (° C.) | Tₘₐₓ (min) | Time (min) |
| Example 12 | 1500 | 9 | 33 |
| Example 13 | 1500 | 4.5 | 16.5 |
| Example 14 | 1500 | 2.25 | 8.25 |
| Example 15 | 1500 | 1.5 | 5.5 |
| Example 16 | 1500 | 12 | 33 |
| Example 17 | 1500 | 6 | 16.5 |
| Example 18 | 1500 | 3 | 8.25 |
| Example 19 | 1500 | 2 | 5.5 |
| Example 20 | 1450 | 9 | 33 |
| Example 21 | 1450 | 4.5 | 16.5 |
| Example 22 | 1450 | 2.25 | 8.25 |
| Example 23 | 1450 | 12 | 33 |
| Example 24 | 1450 | 6 | 16.5 |
| Example D | 1450 | 1.5 | 5.5 |
| Example E | 1450 | 3 | 8.25 |
| Example F | 1450 | 2 | 5.5 |

TABLE 5
Microstructure of Examples 12-24 and C-E

| | Porosity | Min Grain | Mean Grain | Max Grain |
|---|---|---|---|---|
| | (%) | Size (μm) | Size (μm) | Size (μm) |
| Example 12 | 0.52 | 0.62 | 0.78 | 1.25 |
| Example 13 | 1.32 | 0.55 | 0.73 | 1.25 |
| Example 14 | 2.48 | 0.55 | 0.71 | 1.00 |
| Example 15 | 3.85 | 0.55 | 0.70 | 0.83 |
| Example 16 | 0.48 | 0.71 | 0.86 | 1.66 |
| Example 17 | 1.02 | 0.62 | 0.83 | 1.00 |
| Example 18 | 2.45 | 0.50 | 0.69 | 0.83 |
| Example 19 | 3.37 | 0.55 | 0.68 | 1.00 |
| Example 20 | 0.96 | 0.71 | 0.89 | 1.25 |
| Example 21 | 1.89 | 0.62 | 0.76 | 1.25 |
| Example 22 | 3.76 | 0.55 | 0.63 | 0.83 |
| Example 23 | 0.81 | 0.62 | 0.74 | 1.00 |
| Example 24 | 2.33 | 0.55 | 0.66 | 0.83 |
| Example D | 6.04 | 0.50 | 0.63 | 0.71 |
| Example E | 4.33 | 0.50 | 0.61 | 0.71 |
| Example F | 6.08 | 0.55 | 0.61 | 0.71 |

Table 5 presents properties of the microstructure measured for Examples 12-24, measured as described above. Examples 12-24 have less than 4% porosity while Examples D-F have from 4.3% to 6.1% porosity. Examples 12, 16, 20, and 23 have a porosity of less than 1% and have the longest time at the maximum temperature (and longest total heating time of Examples 12-24). This suggests that porosity similar to that of Examples 2-11 (using two firing steps) can be obtained with the one firing step of Examples 12, 16, 20, and 23.

The mean grain size of Examples 12-24 and D-F is from 0.6 μm to 0.9 μm. The grain size of Examples 12-24 is lower than that for Examples 1-9. As discussed above, smaller mean grain sizes are believed to be associated with higher ionic conductivity, so the single firing step of Examples 12-24 is expected to provide comparable or improved ionic conductivity measurements to those of Examples 1-11. The maximum grain size of Examples 12-24 and D-F is from 0.7 μm to 1.7 μm (from 0.8 μm to 1.3 μm for Examples 12-15 and 17-24). Examples 12-15, 17-24, and D-F have lower maximum grain size values than Examples 1-9. The narrower grain size distribution of Examples 12-24 (especially Examples 12-15 and 17-24 with a range of about 0.6 μm or less or +/−75% of the mean grain size—and Examples 14-15 and 17-19 with a range of about 0.5 μm or less or +/−50% of the mean grain size) are also expected to provide increased ionic conductivity.

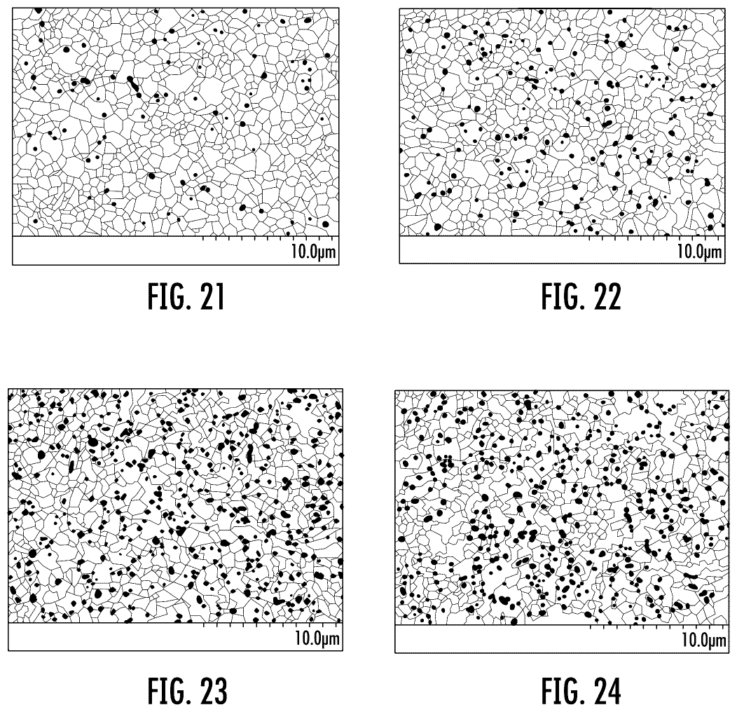

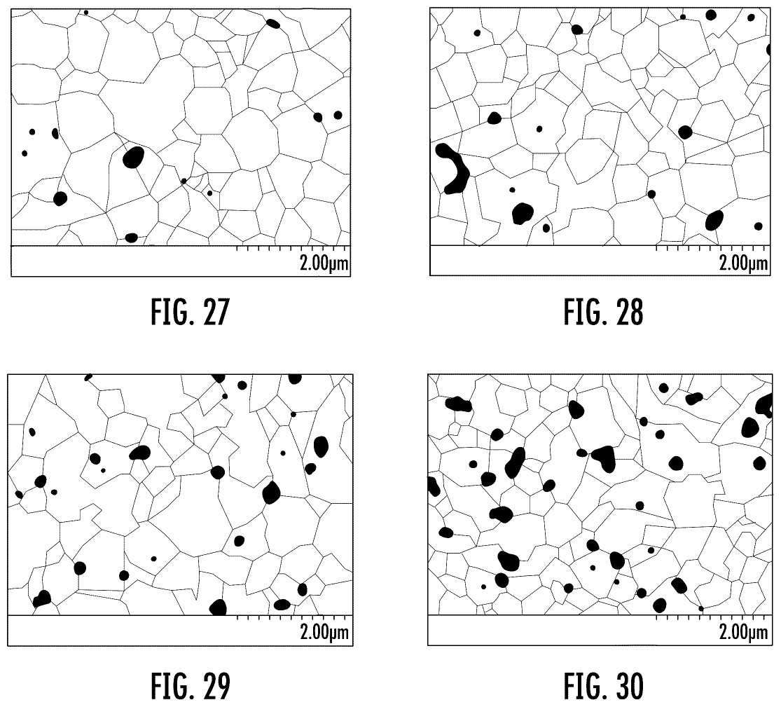

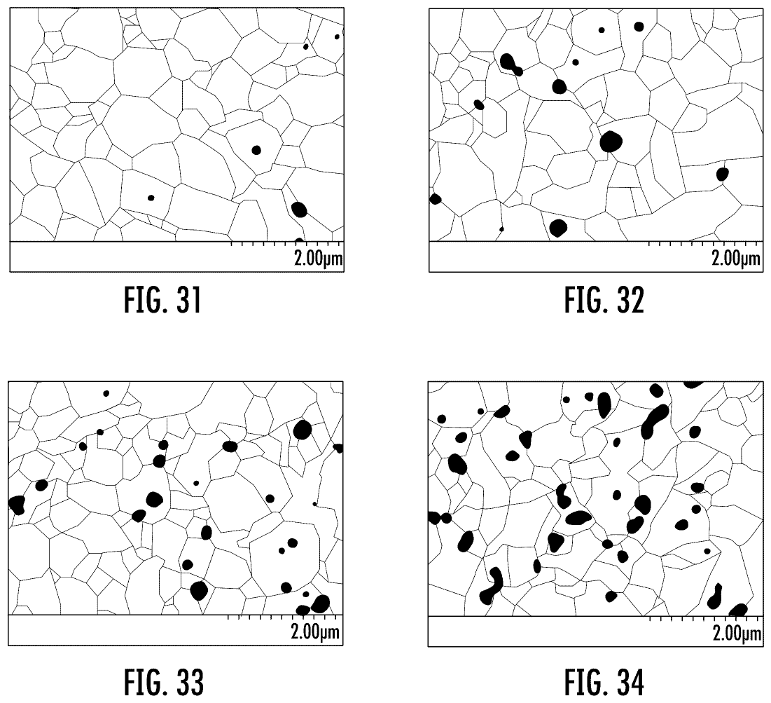

FIGS. 27-30 represent SEM images of cross-sections of Examples 11-15, FIGS. 31-34 represent SEM images of cross-sections of Examples 16-19, FIGS. 31-34 represent SEM images of cross-sections of Examples 20-24. In FIGS. 21-24 and 27-34, the grain boundaries are shown by the lines and the pores are shown as solid black shapes (to increase reproducibility compared to the experimental grayscale images). As shown in FIGS. 27 and 31 show all of the pores (or all but one of the pores) being within a grain, which is counted as a closed pore. FIGS. 28-30, 32-34, 36-37, and 39 have more pores than FIGS. 10-12 and 15-17 consistent with the trend observed in Table 2. Still, a majority of the pores shown in FIGS. 28-30 and 32-39 are within a grain, which is counted a closed pore. Consequently, Examples 12-24 demonstrate a predominantly closed porosity. FIGS. 21-24 represent zoomed-out SEM images (relative to FIGS. 27-30) of Examples 11-15, respectively.

The above observations can be combined to provide a solid-state electrolyte sheet, solid-oxide fuel cell, solid oxide electrolyzer cell, and methods of making the same. The solid-state electrolyte sheet can achieve high ionic conductivity (e.g., 6.5 S/cm or more at 800° C., 9.5 S/cm or more at 850° C., 13.0 S/cm or more at 900° C., or 18.0 S/cm or more at 950° C.) formed as a result of the methods of the present disclosure. Examples 1-24 demonstrate an unexpected benefit of increased ionic conductivity beyond that reported in the prior art under similar conditions. Without wishing to be bound by theory, it is believed that the closed porosity, small average grain size, small maximum grain size, and/or low porosity contribute to the unexpectedly high ionic conductivity. Without wishing to be bound by theory, it is believed that providing a low average grain size (e.g., from 0.1 μm to 2.5 μm or from 0.1 μm to 1.5 μm) can increase the ionic conductivity, for example, by decreasing a path length along grain boundaries that could be travelled by ion transported through the solid-state electrolyte sheet. Without wishing to be bound by theory, it is believed that by limiting a maximum grain size, the ionic conductivity can be increased, for example, by decreasing a path length along grain boundaries that could be travelled by ion transported through the solid-state electrolyte sheet and/or by providing additional grain boundary per volume of the solid-state electrolyte. Providing a majority of pores as closed pores can enable an increased ionic conductivity. Also, providing a majority of pores as closed pores can facilitate longevity of the resulting solid oxide fuel cell and/or solid oxide electrolyzer cell, for example, by reducing an incidence of short circuiting the cell through the solid state electrolyte sheet (e.g., in the case of an open pore providing a path from the first major surface to the second major surface).

Methods of the present disclosure can enable the formation of long ribbons of the solid-state electrolyte sheet. Firing a green tape to form the solid-state electrolyte sheet can comprise a single firing step or a plurality of firing steps. The one or more firing steps can comprise heating at a maximum temperature of 1650° C. or less (or 1625° C. or less or 1600° C. or less), which can facilitate formation of the microstructure (e.g., grain size, porosity, and/or associated grain size distribution) associated with the increased ionic conductivity of the solid-state electrolyte sheets of the present disclosure. Heating the green tape (at temperatures of 600° C. or more) for 90 minutes or less (e.g., from 5 minutes to 60 minutes) can reduce resource requirements and/or increase a throughput of the method. Also, a maximum period of time at the maximum temperature of from 10 seconds to 20 minutes or from 5% to 20% of the period of time in the firing step at temperatures of 600° C. or more can reduce resource requirements (e.g., energy) of the method.

What is claimed is:

1. A solid-state electrolyte sheet comprising:
scandia-stabilized zirconia grains comprising from about 3 mol % to about 6 mol % scandia;
a thickness in a range from about 10 micrometers to about 300 micrometers; and
an ionic conductivity at 850° C. of 9.5 S/cm or more.

2. The solid-state electrolyte sheet of claim 1, wherein the ionic conductivity is 9.8 S/cm or more.

3. The solid-state electrolyte sheet of claim 1, wherein the scandia-stabilized zirconia grains comprise about 6 mol % scandia.

4. The solid-state electrolyte sheet of claim 1, wherein the thickness is from about 20 micrometers to about 50 micrometers.

5. The solid-state electrolyte sheet of claim 1, wherein the solid-state electrolyte sheet comprises a porosity of about 4% or less.

6. The solid-state electrolyte sheet of claim 1, wherein a majority of pores in the solid-state electrolyte sheet is a closed porosity.

7. The solid-state electrolyte sheet of claim 1, wherein an average grain size of the scandia-stabilized zirconia grains is from 0.1 μm to 2.5 μm.

8. The solid-state electrolyte sheet of claim 1, wherein a maximum grain size of the scandia-stabilized zirconia grains is less than 5 μm.

9. The solid-state electrolyte sheet of claim 1, wherein the scandia-stabilized zirconia grains are substantially free of at least one of alumina, yttria, a lanthanoid oxide, or combinations thereof.

10. The solid-state electrolyte sheet of claim 1, wherein the solid-state electrolyte sheet exhibits an edge strength of 350 MegaPascals or more as measured in a Two-Point Bend Test.

11. The solid-state electrolyte sheet of claim 1, wherein a curvature of the solid-state electrolyte sheet is 10 Diopters or less.

12. The solid-state electrolyte sheet of claim 1, wherein the solid-state electrolyte sheet exhibits a total-indicated-range of 1 millimeter or less over a distance of 25 mm or more.

13. The solid-state electrolyte sheet of claim 1, wherein a predominant crystal phase of the scandia-stabilized zirconia grains is tetragonal.

14. A solid-state electrolyte sheet comprising:
scandia-stabilized zirconia grains comprising from about 3 mol % to about 11 mol % scandia;
a thickness in a range from about 10 micrometers to about 300 micrometers;
an average grain size of the scandia-stabilized zirconia grains is from 0.1 μm to 2.5 μm; and
a majority of pores in the solid-state electrolyte sheet is a closed porosity.

15. The solid-state electrolyte sheet of claim 14, wherein the solid-state electrolyte sheet comprises a porosity of about 4% or less.

16. The solid-state electrolyte sheet of any one of claim 14, wherein a maximum grain size of the scandia-stabilized zirconia grains is less than 5 μm.

17. The solid-state electrolyte sheet of claim 14, wherein the thickness is from about 20 micrometers to about 50 micrometers.

18. The solid-state electrolyte sheet of claim 14, wherein the solid-state electrolyte sheet comprises an ionic conductivity at 900° C. of 13.2 S/cm or more.

19. The solid-state electrolyte sheet of claim 14, wherein a predominant crystal phase of the scandia-stabilized zirconia grains is tetragonal.

20. A solid oxide fuel cell comprising:
the solid-state electrolyte sheet of claim 1 comprising a first major surface and a second major surface with the thickness defined therebetween;
an oxygen electrode disposed on the first major surface; and
a fuel electrode disposed on the second major surface.
